(19) United States
(12) Patent Application Publication
(10) Pub. No.: US 2026/0239093 A1
(43) Pub. Date: Aug. 13, 2026

(54) SIDELINK POSITIONING TECHNIQUE

(71) Applicant: Telefonaktiebolaget LM Ericsson (publ), Stockholm (SE)

(72) Inventors: Xiaolin JIANG, Linköping (SE); Ritesh SHREEVASTAV, Upplands Väsby (SE); Min WANG, Luleå (SE)

(73) Assignee: Telefonaktiebolaget LM Ericsson (publ), Stockholm (SE)

(21) Appl. No.: 19/153,337

(22) PCT Filed: Feb. 8, 2024
(86) PCT No.: PCT/EP2024/053265

§ 371 Date: Aug. 3, 2025

Related U.S. Application Data
(60) Provisional application No. 63/444,181, filed on Feb. 8, 2023.

(51) Int. Cl. H04W 28/02; H04W 64/00; H04W 92/18

(52) U.S. Cl. CPC H04W 28/0268; H04W 64/00; H04W 92/18

(57) ABSTRACT

As to a method aspect of the technique, a method performed by a candidate assisting radio device or assisting radio device for sidelink positioning, SL positioning, of a target radio device using a SL between the target radio device and the assisting radio device is described. The method comprises transmitting a control message indicative of a Quality of Service, QoS, supported by the candidate assisting radio device for the SL positioning. Alternatively or in addition, the method comprises receiving a control message indicative of a QoS required for the SL positioning. Alternatively or in addition, the method comprises assisting the SL positioning as the assisting radio device if the candidate assisting radio device fulfills the required QoS and/or based on the supported QoS.

### TECHNICAL FIELD

The present disclosure relates to a technique for positioning, including in particular ranging, of a radio device using a sidelink between radio devices. More specifically, and without limitation, methods and devices are provided for sidelink positioning and assisting sidelink positioning.

### BACKGROUND

The Third Generation Partnership Project (3GPP) defined sidelinks (SLs) in Release 12 as an adaptation of the Long Term Evolution (LTE) radio access technology for direct communication between two radio devices, also referred to as user equipment (UE), without going through a base station. Such device-to-device (D2D) communications through SLs are also referred to as proximity service (ProSe) and can be used for Public Safety communications.

Furthermore, positioning and/or ranging, which is also referred to as location services (LCS) or collectively as positioning, have been included in the standardization of fourth generation (4G) radio access technology (RAT) such as Long Term Evolution (LTE) since 3GPP Release 9. Conventionally, positioning uses an interface between a network node (e.g., a gNodeB) of a radio access network (RAN) and a radio device (e.g., a 3GPP user equipment, UE) such as a Uu interface.

A primary objective of positioning is to fulfill regulatory requirements for emergency call positioning. Positioning in fifth generation (5G) RAT such as 3GPP New Radio (NR) has been proposed to be supported via the radio interface (Uu interface) between the network node and the radio device.

Depending on the use case, SL sessions for SL positioning are imposed with different QoS requirements for the positioning. Such QoS requirements would further require the radio devices assisting in the SL positioning to be capable of providing SL sessions according to the QoS requirement.

### SUMMARY

Accordingly, there is a need for a sidelink positioning technique that takes quality of service requirements (QoS) into account.

As to a first method aspect, a method performed by a candidate assisting radio device or assisting radio device for sidelink positioning (SL positioning) of a target radio device using a SL between the target radio device and the assisting radio device is provided. The method comprises at least one of transmitting a control message indicative of a Quality of Service (QoS) supported by the candidate assisting radio device for the SL positioning; receiving a control message indicative of a QoS required for the SL positioning; and assisting the SL positioning as the assisting radio device if the candidate assisting radio device fulfills the required QoS and/or based on the supported QoS.

The required QoS may be referred to as QoS requirement. The target radio device, or a service (or an application) used or performed by the target, may determine or define the required QoS.

The supported QoS may be referred to as QoS support. The assisting radio device (e.g., the respective one of the at least one assisting radio device) may determine or define the supported QoS. Alternatively or in addition, the supported QoS may depend on a channel state between the assisting radio device and the target radio device or an interference level or a noise level at the assisting radio device.

Herein, SL positioning may encompass positioning and/or ranging using the SL, e.g. a SL transmission or a SL reception.

Herein, the SL may encompass a radio channel between the target radio device and the assisting radio device and/or without a network node of a radio access network (RAN). The SL may comprise a direct radio channel or may comprise one or more relay radio devices (or hops) between the target radio device and the assisting radio device.

Assisting the SL positioning as the assisting radio device based on the supported QoS may comprise assisting the SL positioning responsive to a message that is based on the supported QoS and/or that is received from the target radio device or a core node (e.g. PCF, AF, AMF, or LMF).

The candidate assisting radio device may be a radio device (e.g., within the range of the SL and/or a neighbor of the target radio device), e.g., prior to assessing whether or not the supported QoS fulfills the required QoS. The candidate assisting radio device may be an assisting radio device if (e.g., only if) the supported QoS fulfills the required QoS. Herein, the at least one assisting radio device may be the subset of the at least one candidate assisting radio device fulfilling the QoS requirement.

The control message (e.g., according to the first method aspect) may be received from the target radio device. Alternatively or in addition, the received control message may be a discovery message or may be received in a direct discovery for the SL or in direct communications using the SL. Alternatively or in addition, the received control message may be indicative of an application identifier (ID). For example, the application ID may be indicative of—or associated with—the QoS required by the target radio device.

The at least one candidate assisting radio device may use its application ID to indicate the QoS supported for SL positioning. Alternatively or in addition, the target radio device may use its registration to indicate the QoS required for the SL positioning (e.g., its QoS requirement).

The transmitting of a control message, e.g., according to the first method aspect, may comprise transmitting a first control message. Alternatively or in addition, the (e.g., first) control message may be a registration request message and/or a message for service authorization and/or a policy request message. Alternatively or in addition, the (e.g., first) control message may be transmitted to a policy control function (PCF) or an application function (AF) or an access and mobility management function (AMF). Alternatively or in addition, the (e.g., first) control message may be indicative of a radio device capability of the candidate assisting radio device and/or the QoS supported for the SL positioning. Alternatively or in addition, the received control message may be indicative of a policy for the SL and/or an application identifier (ID) for the SL. Alternatively or in addition, the application ID may be indicative of or associated with the supported QoS. Alternatively or in addition, the transmitting of a control message further may comprise transmitting a second control message to the target radio device. Alternatively or in addition, the second control message may be indicative of the application ID. Alternatively or in addition, second control message may be a discovery message or may be transmitted in a direct discovery for the SL or in direct communications using the SL.

The radio device capability of the (e.g., candidate) assisting radio device may include the QoS supported for the SL positioning. The radio device capability may be a UE capability. Alternatively or in addition, the application ID may be used as service identifier (e.g., ProSe identifier in ProSe direct discovery), e.g. of the SL.

Herein, referring to an application may, alternatively or in addition, refer to a service. For example, the application ID may be a session ID. Alternatively or in addition, the application ID may be a SL service or proximity service (ProSe) ID.

Herein, the policy for the SL may comprise one or more parameters for the SL. Alternatively or in addition, the policy for the SL may be a ProSe policy.

The (e.g., first) control message may be transmitted to a core node, e.g. the PCF and/or the AF and/or the AMF and/or the LMF. Alternatively or in addition, the core node may be a function or unit or node of a core network (CN) serving the RAN.

The received control message may be received from the core node and/or in response to the transmitted (e.g., first) control message.

The method (e.g., according to the first method aspect) may further comprise performing a SL discovery procedure with the target radio device or establishing a SL session with the target radio device. The control message indicative of the QoS supported by the candidate assisting radio device for the SL positioning may be transmitted after the SL discovery procedure and/or after establishing the SL session and/or using SL communication in the SL. Alternatively or in addition, the control message indicative of the QoS required for the SL positioning may be received after the SL discovery procedure and/or after establishing the SL session and/or using SL communication in the SL. Alternatively or in addition, the SL positioning may be selectively assisted by the candidate assisting radio device based on the received required QoS being fulfilled by the supported QoS and/or based on an acknowledgment received responsive to the transmitted control message indicative of the supported QoS.

The SL discovery procedure may be a ProSe discovery procedure.

The acknowledgment may be received from the target radio device.

The candidate assisting radio device may selectively reply (e.g., in response to the received control message indicative of the required QoS) to the target radio device if its QoS support fulfills the QoS requirement. Alternatively or in addition, the candidate assisting radio device may receive a response (e.g., the acknowledgment) selectively from the at least one assisting radio device if the QoS support fulfills the QoS requirement.

The transmitting of the control message (e.g., according to the first method aspect) may comprise transmitting a discovery message for discovering the target radio device. The discovery message may be indicative of the QoS supported for the SL positioning. Alternatively or in addition, the receiving of the control message may comprise receiving a discovery message for discovering the target radio device. The discovery message may be indicative of the QoS required for the SL positioning.

The method (e.g., according to the first method aspect) may further comprise receiving, responsive to the transmitted discovery message, a reply message from the target radio device if or only if the supported QoS is fulfilling the required QoS for the SL positioning. Alternatively or in addition, the method (e.g., according to the first method aspect) may comprise transmitting, responsive to the received discovery message, a reply message to the target radio device if or only if the supported QoS is fulfilling the required QoS for the SL positioning.

The reply message may initiate, or may be part of, the assisting of the SL positioning.

The assisting of the SL positioning (e.g., according to the first method aspect) may comprise at least one of receiving a reference signal in the SL from the target radio device to at the assisting radio device and transmitting a reference signal in the SL from the assisting radio device at the target radio device.

Herein, the SL positioning using the SL may or may not require establishing a SL session between the target radio device and the assisting radio device. For example, the reference signal (RS) may be broadcast by the target radio device and/or by the assisting radio device without SL session establishment.

The required QoS (e.g., according to the first method aspect) may be indicative of at least one of an accuracy of the SL positioning, a latency, a packet delay budget, a packet error rate, and a packet loss rate.

The required QoS and/or the supported QoS (e.g., according to the first method aspect) may be expressed via a service and/or traffic type priority indicator, optionally a PC5 QoS indicator (PQI) or a 5G QoS indicator (5QI). Alternatively or in addition, the required QoS and/or the supported QoS may be indicative of at least one of: a session level bit rate of the SL, a bit rate on the SL, aggregated bit rate on a PC5 interface used by the SL, a bit rate of flows, a bit rate of radio bearers, an averaged or maximum packet delay of flows or radio bearers, an averaged or maximum packet error rate of flows or radio bearers, a total delivered data volume of concerned flows or radio bearers, a number of hops that one or multiple packets of a flow or service have traversed, a packet error rate of flows or radio bearers, a number of lost packets of flows or radio bearers, a ratio of packet loss of flows or radio bearers, a positioning accuracy requirement, a bandwidth for transmitting and receiving sidelink reference signal for the SL positioning, and a reference signal received power (RSRP).

The method according to the first method aspect may further comprise the features or the steps of any one of below second method aspect or below third method aspect, or features or steps corresponding thereto.

As to a second method aspect, a method performed by a target radio device for sidelink positioning (SL positioning) of the target radio device using a SL between the target radio device and at least one assisting radio device is provided. The method comprises at least one of receiving a control message indicative of a Quality of Service (QoS) supported by at least one candidate assisting radio device for the SL positioning; transmitting a control message indicative of a QoS required for the SL positioning; and performing the SL positioning using the at least one assisting radio device that fulfills the required QoS and/or based on the supported QoS.

The required QoS may be referred to as QoS requirement. The supported QoS may be referred to as QoS support.

Herein, SL positioning may encompass positioning and/or ranging using the SL, e.g. a SL transmission or a SL reception.

Herein, the SL may encompass a radio channel between the target radio device and the assisting radio device and/or without a network node of a radio access network (RAN). The SL may comprise a direct radio channel or may comprise one or more relay radio devices (or hops) between the target radio device and the assisting radio device.

Performing the SL positioning using the at least one assisting radio device that fulfills the required QoS and/or based on the supported QoS may comprise selecting the at least one assisting radio device based on the respectively supported QoS if it fulfils the required QoS.

The control message (e.g., according to the second method aspect) may be received from the at least one candidate assisting radio device. Alternatively or in addition, the received control message may be a discovery message or may be received in a direct discovery for the SL or in direct communications using the SL. Alternatively or in addition, the received control message may be indicative of an application identifier (ID). Alternatively or in addition, the application ID may be indicative of or may be associated with the QoS supported by the at least one candidate assisting radio device.

The at least one candidate assisting radio device may use its application ID to indicate the QoS supported for SL positioning. Alternatively or in addition, the target radio device may use its registration to indicate the QoS required for the SL positioning (e.g., its QoS requirement).

The transmitting of a control message (e.g., according to the second method aspect) may comprise transmitting a first control message. Alternatively or in addition, the (e.g., first) control message may be a registration request message and/or a message for service authorization and/or a policy request message. Alternatively or in addition, the (e.g., first) control message may be transmitted to a policy control function (PCF), or an application function (AF) or an access and mobility management function (AMF). Alternatively or in addition, the (e.g., first) control message may be indicative of a radio device capability of the target radio device and/or the QoS may be required for the SL positioning. Alternatively or in addition, the received control message may be indicative of a policy for the SL and/or an application identifier (ID) for the SL. Alternatively or in addition, the application ID may be indicative of or may be associated with the required QoS. Alternatively or in addition, the transmitting of a control message may further comprise transmitting a second control message to the at least one candidate assisting radio device. The second control message may be indicative of the application ID. Alternatively or in addition, second control message may be a discovery message or may be transmitted in a direct discovery for the SL or in direct communications using the SL.

The radio device capability of the target radio device may include the QoS required for the SL positioning. The radio device capability may be a UE capability. Alternatively or in addition, the application ID may be used as service identifier (e.g., ProSe identifier in ProSe direct discovery).

Herein, referring to an application may, alternatively or in addition, refer to a service. For example, the application ID may be a session ID. Alternatively or in addition, the application ID may be a SL service or proximity service (ProSe) ID.

Herein, the policy for the SL may comprise one or more parameters for the SL. Alternatively or in addition, the policy for the SL may be a ProSe policy.

The PCF and/or the AF may be a function or node of a core network (CN) serving the RAN.

The method (e.g., according to the second method aspect) may further comprise performing a SL discovery procedure with at least one candidate assisting radio device or establishing a SL session with at least one candidate assisting radio device. The control message indicative of the QoS supported by the at least one candidate assisting radio device for the SL positioning may be received after the SL discovery procedure and/or after establishing the SL session and/or using SL communication in the SL. Alternatively or in addition, the control message indicative of the QoS required for the SL positioning may be transmitted after the SL discovery procedure and/or after establishing the SL session and/or using SL communication in the SL. Alternatively or in addition, the SL positioning may be performed using the at least one assisting radio device selected out of the at least one candidate assisting radio device based on the received supported QoS fulfilling the required QoS and/or based on an acknowledgment received responsive to the transmitted control message indicative of the required QoS.

The SL discovery procedure may be a ProSe discovery procedure.

The target radio device may selectively reply to the at least one assisting radio device if the QoS support fulfills the QoS requirement. Alternatively or in addition, the target radio device may receive a response selectively from the at least one assisting radio device if the QoS support fulfills the QoS requirement.

The transmitting of the control message (e.g., according to the second method aspect) may comprise transmitting a discovery message for discovering the at least one assisting radio device. The discovery message may be indicative of the QoS required for the SL positioning. Alternatively or in addition, the receiving of the control message may comprise receiving a discovery message for discovering the at least one assisting radio device. The discovery message may be indicative of the QoS supported for the SL positioning.

The method (e.g., according to the second method aspect) may further comprise receiving, responsive to the transmitted discovery message, a reply message from the at least one assisting radio device, each of which may be capable of fulfilling the QoS requirement for the SL positioning. Alternatively or in addition, the method (e.g., according to the second method aspect) may further comprise transmitting, responsive to the received discovery message, a reply message to the at least one assisting radio device capable of fulfilling the QoS requirement for the SL positioning.

The reply message may initiate, or may be part of, the performing of the SL positioning.

The performing of the SL positioning (e.g., according to the second method aspect) may comprise at least one of transmitting a reference signal in the SL from the target radio device to at least one assisting radio device and receiving a reference signal in the SL from the at least one assisting radio device at the target radio device.

Herein, the SL positioning using the SL may or may not require establishing a SL session between the target radio device and the assisting radio device. For example, the RS may be broadcast by the target radio device and/or by the assisting radio device without a SL session establishment.

The QoS requirement (e.g., according to the second method aspect) may be indicative of at least one of an accuracy of the SL positioning, a latency, a packet delay budget, a packet error rate, and a packet loss rate.

The method (e.g., according to the second method aspect), wherein the required QoS and/or the supported QoS may be expressed via a service and/or traffic type priority indicator, optionally PQI or 5QI. Alternatively or in addition, the required QoS and/or the supported QoS may be indicative of at least one of: a session level bit rate of the SL, a bit rate on the SL, aggregated bit rate on a PC5 interface used by the SL, a bit rate of flows, a bit rate of radio bearers, an averaged or maximum packet delay of flows or radio bearers, an averaged or maximum packet error rate of flows or radio bearers, a total delivered data volume of concerned flows or radio bearers, a number of hops that one or multiple packets of a flow or service have traversed, a packet error rate of flows or radio bearers, a number of lost packets of flows or radio bearers, a ratio of packet loss of flows or radio bearers, a positioning accuracy requirement, a bandwidth for transmitting and receiving sidelink reference signal for the SL positioning, and a reference signal received power (RSRP).

The method according to the second method aspect may further comprise the features or the steps of any one of the above first method aspect or below third method aspect, or features or steps corresponding thereto.

As to a third method aspect, a method performed by a node of a network, optionally by a core node of a core network, for sidelink positioning (SL positioning) of a target radio device using a SL between the target radio device and at least one assisting radio device is provided. The method comprises at least one of receiving a control message indicative of a Quality of Service (QoS) supported for the SL positioning from the at least one candidate assisting radio device; receiving a control message indicative of a QoS required for the SL positioning from the target radio device; transmitting a control message indicative of a QoS supported by at least one candidate assisting radio device for the SL positioning to the at least one candidate assisting radio device; and transmitting a control message indicative of a QoS required by the target radio device for the SL positioning to the target radio device.

The method may be performed by a core node, e.g. a policy control function (PCF), an application function (AF), an access and mobility management function (AMF), or a location management function (LMF).

The network may comprise at least one of a radio access network (RAN) and a core network (CN).

The receiving of a control message (e.g., according to the third method aspect) may comprise receiving a first control message. Alternatively or in addition, the (e.g., first) control message may be a registration request message and/or a message for service authorization and/or a policy request message. Alternatively or in addition, the (e.g., first) control message may be indicative of a radio device capability of the at least one candidate assisting radio device and/or the QoS supported for the SL positioning. Alternatively or in addition, the control message transmitted to the at least one candidate assisting radio device may be indicative of a policy for the SL and/or an application identifier (ID) for the SL. Alternatively or in addition, the application ID may be indicative of or associated with the supported QoS.

The receiving of a control message (e.g., according to the third method aspect) may comprise receiving a first control message. Alternatively or in addition, the (e.g., first) control message may be a registration request message and/or a message for service authorization and/or a policy request message. Alternatively or in addition, the (e.g., first) control message may be indicative of a radio device capability of the target radio device and/or the QoS required for the SL positioning. Alternatively or in addition, the control message transmitted to the target radio device may be indicative of a policy for the SL and/or an application identifier (ID) for the SL. Alternatively or in addition, the application ID may be indicative of or associated with the required QoS.

While the technique is described for an application ID indicative of the (e.g., required or supported) QoS, any other parameter (e.g., any authorization parameter) in the policy indicative of the (e.g., required or supported) QoS may replace the application ID according to a variant of any embodiment.

In any aspect, the candidate assisting radio device may be an assisting radio device, e.g., if it fulfills the QoS requirement for the SL positioning. Alternatively or in addition, the candidate assisting radio device may be a neighboring radio device of the target radio device or any radio device that is within range of the SL.

The node (e.g., according to the third method aspect) may transmit a control message to each of a plurality of candidate assisting radio devices. Alternatively or in addition, different application IDs may be provided to differentiate SL positioning with differently supported QoS. Alternatively or in addition, the node may transmit a control message to each of a plurality of target radio devices. Alternatively or in addition, different application IDs are provided to differentiate SL positioning with different QoS requirements.

The method according to the third method aspect may further comprise the features or the steps of any one of the above first method aspect or the above second method aspect, or features or steps corresponding thereto.

As to another aspect, a computer program product is provided. The computer program product comprises program code portions for performing the steps of any one of the first method aspect or the second method aspect or the third method aspect when the computer program product is executed on one or more computing devices. Alternatively or in addition, the computer program product stored on a computer-readable recording medium.

As to a first device aspect, a radio device comprising memory operable to store instructions and processing circuitry operable to execute the instructions is provided. The radio device is operable to at least one of transmit a control message indicative of a Quality of Service (QoS) supported by the radio device for the SL positioning; receive a control message indicative of a QoS required for the SL positioning; and assist the SL positioning as the assisting radio device if the radio device fulfills the required QoS and/or based on the supported QoS.

The radio device (e.g., according to the first device aspect) may further be operable to perform any one of the steps of the first method aspect.

As to another first device aspect, a radio device is provided. The radio device configured to at least one of transmit a control message indicative of a Quality of Service (QoS) supported by the radio device for the SL positioning; receiving a control message indicative of a QoS required for the SL positioning; and assist the SL positioning as the assisting radio device if the radio device fulfills the required QoS and/or based on the supported QoS.

The radio device (e.g., according to the other first device aspect) may further be configured to perform any one of the steps of the first method aspect.

As to a second device aspect, a radio device comprising memory operable to store instructions and processing circuitry operable to execute the instructions is provided. The radio device is operable to at least one of receive a control message indicative of a Quality of Service (QoS) supported by at least one candidate assisting radio device for the SL positioning; transmit a control message indicative of a QoS required for the SL positioning; and perform the SL positioning using the at least one assisting radio device that fulfills the required QoS and/or based on the supported QoS.

The radio device (e.g., according to the second device aspect) may further be operable to perform any one of the steps of the second method aspect.

As to another second device aspect, a radio device is provided. The radio device is configured to at least one of receive a control message indicative of a Quality of Service (QoS) supported by at least one candidate assisting radio device for the SL positioning; transmit a control message indicative of a QoS required for the SL positioning; and perform the SL positioning using the at least one assisting radio device that fulfills the required QoS and/or based on the supported QoS.

The radio device (e.g., according to the other second device aspect) may further configured to perform any one of the steps of the second method aspect.

As to a third device aspect, a network node comprising memory operable to store instructions and processing circuitry operable to execute the instructions is provided. The network node is operable to at least one of receive a control message indicative of a Quality of Service (QoS) supported for the SL positioning from the at least one candidate assisting radio device; receive a control message indicative of a QoS required for the SL positioning from the target radio device; transmit a control message indicative of a QoS supported by at least one candidate assisting radio device for the SL positioning to the at least one candidate assisting radio device; and transmit a control message indicative of a QoS required by the target radio device for the SL positioning to the target radio device.

The network node (e.g., according to the third device aspect) may further be operable to perform any one of the steps of the third method aspect.

As to another third device aspect, a network node is provided. The network node configured to at least one of receive a control message indicative of a Quality of Service (QoS) supported for the SL positioning from the at least one candidate assisting radio device; receive a control message indicative of a QoS required for the SL positioning from the target radio device; transmit a control message indicative of a QoS supported by at least one candidate assisting radio device for the SL positioning to the at least one candidate assisting radio device; and transmit a control message indicative of a QoS required by the target radio device for the SL positioning to the target radio device.

The network node (e.g., according to the other third device aspect) may further be operable to perform any one of the steps of the third method aspect.

As to a system aspect a communication system including a host computer is provided. The communication system comprises processing circuitry configured to provide user data; and a communication interface configured to forward user data to a cellular or ad hoc radio network for transmission to a user equipment (UE) wherein the UE comprises a radio interface and processing circuitry, the processing circuitry of the UE being configured to execute any one of the steps of the first method aspect and the second method aspect.

The communication system (e.g., according to the system aspect) may further including the UE.

The communication system (e.g., according to the system aspect), wherein the radio network may further comprise a base station, or a radio device functioning as a gateway, which is configured to communicate with the UE.

The communication system (e.g., according to the system aspect), wherein the base station, or the radio device functioning as a gateway, may comprise processing circuitry, which may be configured to execute any one of the steps of the third method aspect.

The communication system (e.g., according to the system aspect), wherein the processing circuitry of the host computer may be configured to execute a host application, thereby providing the user data; and the processing circuitry of the UE may be configured to execute a client application associated with the host application.

The first method aspect may be performed by the candidate assisting radio device, which may be selectively the assisting radio device of the SL positioning.

In any aspect, embodiments of the technique enable the radio devices (e.g., the assisting and/or target radio devices) to determine whether or not the QoS required by the target radio device is met by a candidate assisting radio device, e.g. before the respective candidate assisting radio device is used or selected as assisting radio device for the SL positioning.

The second method aspect may be performed by the target assisting radio device.

The second method aspect may further comprise any feature and/or any step disclosed in the context of the first method aspect, or a feature and/or step corresponding thereto, e.g., a receiver counterpart to a transmitter feature or step.

The third method aspect may be performed by the core node, e.g. a node of the core network that provides control policies to the radio devices and/or that computes positions based on measurements reported by the radio devices. For example, the third method aspect may be performed by a policy control function (PCF), an application function (AF), an access and mobility management function (AMF), or a location management function (LCM).

The third method aspect may further comprise any feature and/or any step disclosed in the context of the first and/or second method aspect, or a feature and/or step corresponding thereto, e.g., a network counterpart to a radio device feature or step.

Without limitation, for example in a 3GPP implementation, any “radio device” may be a user equipment (UE). Any one of the method aspects may be embodied by a method of establishing a UE relaying connection with a desired QoS.

The technique may be applied in the context of 3GPP New Radio (NR). Unlike a SL according to 3GPP LTE, a SL according to 3GPP NR can provide a wide range of QoS levels. Therefore, at least some embodiments of the technique can ensure that the SL positioning for the QoS of the traffic is selected.

The technique may be implemented in accordance with a 3GPP specification, e.g., for 3GPP release 17 or 18. The technique may be implemented for 3GPP LTE or 3GPP NR according to a modification of the 3GPP document TS 23.303, version 16.0.0 or for 3GPP NR according to a modification of the 3GPP document TS 33.303, version 16.0.0.

Alternatively or in addition, the technique may be implemented according to a modification of at least one of the following 3GPP documents (e.g., in Release 18): TS 24.334, TS 38.331, TS 38.305, TS 23.273, TS 23.501, and TS 23.502.

In any radio access technology (RAT), the technique may be implemented as a method of sidelink positioning (SL positioning or briefly: positioning) and/or sidelink ranging (SL ranging or briefly: ranging). Alternatively or in addition, the method may indicate or depend on a Quality of Service (QoS) of the positioning and/or the ranging (briefly: positioning QoS). Alternatively or in addition, the method may be implemented as a method of SL discovery. For example, a discovery message for the SL (e.g., a proximity services discovery message (ProSe discovery message) may be indicative of the positioning QoS.

Any radio device may be a user equipment (UE), e.g., according to a 3GPP specification. The assisting radio device may also be referred to as an assisting UE. Alternatively or in addition, the target radio device may also be referred to as a target UE.

At least some of the radio devices and the RAN may be wirelessly connected in an uplink (UL) and/or a downlink (DL) through a Uu interface. Alternatively or in addition, the SL may enable a direct radio communication between proximal radio devices, e.g., the assisting radio device and the target radio device, optionally using a PC5 interface; or between assisting radio device for time synchronization.

Services provided using the SL or the PC5 interface may be referred to as proximity services (ProSe). Any radio device (e.g., the assisting radio device and/or the target radio device) supporting a SL may be referred to as ProSe-enabled radio device.

If present, a relay radio device may also be referred to as ProSe UE-to-Network Relay.

The one or more assisting radio devices and/or the target radio device and/or the RAN may form, or may be part of, a radio network, e.g., according to the Third Generation Partnership Project (3GPP) or according to the standard family IEEE 802.11 (Wi-Fi). The first method aspect, the second method aspect and third method aspect may be performed by one or more embodiments of the assisting radio device, the target radio device and a core network serving the RAN (e.g., network nodes or base stations of the RAN), respectively.

The RAN may comprise one or more network nodes (e.g., base stations), e.g., performing the third method aspect. Alternatively or in addition, the radio network may be a vehicular, ad hoc and/or mesh network comprising two or more radio devices, e.g., acting as the remote radio device and/or the relay radio device and/or the further remote radio device.

Any of the radio devices may be a 3GPP user equipment (UE) or a Wi-Fi station (STA). The radio device may be a mobile or portable station, a device for machine-type communication (MTC), a device for narrowband Internet of Things (NB-IoT) or a combination thereof. Examples for the UE and the mobile station include a mobile phone, a tablet computer and a self-driving vehicle. Examples for the portable station include a laptop computer and a television set. Examples for the MTC device or the NB-IoT device include robots, sensors and/or actuators, e.g., in manufacturing, automotive communication and home automation. The MTC device or the NB-IoT device may be implemented in a manufacturing plant, household appliances and consumer electronics.

Whenever referring to the RAN, the RAN may be implemented by one or more base stations.

The remote radio device may be wirelessly connected or connectable (e.g., according to a radio resource control, RRC, state or active mode) with the relay radio device and, optionally, at least one base station of the RAN. The relay radio device may be wirelessly connected or connectable (e.g., according to a radio resource control, RRC, state or active mode) with at least one base station of the RAN and/or the further remote radio device. Furthermore, the relay radio device may be wirelessly connected or connectable (e.g., according to 3GPP ProSe) with the remote radio device.

The network node (or base station) may encompass any station that is configured to provide radio access to any of the radio devices. The base stations may also be referred to as cell, transmission point (TP) or transmission and reception point (TRP), radio access node or access point (AP). The base station and/or the relay radio device may provide a data link to a host computer providing the user data to the remote radio device or gathering user data from the remote radio device. Examples for the base stations may include a 3G base station or Node B (NB), 4G base station or eNodeB (eNB), a 5G base station or gNodeB (gNB), a Wi-Fi AP and a network controller (e.g., according to Bluetooth, ZigBee or Z-Wave).

The RAN may be implemented according to the Global System for Mobile Communications (GSM), the Universal Mobile Telecommunications System (UMTS), 3GPP Long Term Evolution (LTE) and/or 3GPP New Radio (NR).

Any aspect of the technique may be implemented on a Physical Layer (PHY), a Medium Access Control (MAC) layer, a Radio Link Control (RLC) layer, a packet data convergence protocol (PDCP) layer, a Radio Resource Control (RRC) layer of a protocol stack for the radio communication, and/or a non-access stratum (NAS) between the radio device and the core network (CN).

Herein, referring to a protocol of a layer may also refer to the corresponding layer in the protocol stack. Vice versa, referring to a layer of the protocol stack may also refer to the corresponding protocol of the layer. Any protocol may be implemented by a corresponding method.

As to another aspect, a computer program product is provided. The computer program product comprises program code portions for performing any one of the steps of the first, second and/or third method aspect disclosed herein when the computer program product is executed by one or more computing devices. The computer program product may be stored on a computer-readable recording medium. The computer program product may also be provided for download, e.g., via the radio network, the RAN, the Internet and/or the host computer. Alternatively, or in addition, the method may be encoded in a Field-Programmable Gate Array (FPGA) and/or an Application-Specific Integrated Circuit (ASIC), or the functionality may be provided for download by means of a hardware description language.

The devices may be configured to perform any one of the steps of the respective method aspect. Alternatively or in addition, any of the devices comprises processing circuitry (e.g., at least one processor and a memory). Said memory comprises instructions executable by said at least one processor whereby the device is operative to perform any one of the steps of the respective method aspect.

As to a still further aspect a communication system including a host computer is provided. The host computer comprises a processing circuitry configured to provide user data. The host computer further comprises a communication interface configured to forward the user data to a cellular network (e.g., the RAN and/or the base station) for transmission to a UE. A processing circuitry of the cellular network is configured to execute any one of the steps of the third method aspects. The UE comprises a radio interface and processing circuitry, which is configured to execute any one of the steps of the first and/or second method aspects.

The communication system may further include the UE. Alternatively, or in addition, the cellular network may further include one or more base stations configured for radio communication with the UE and/or to provide a data link between the UE and the host computer using the first and/or second and/or third method aspects.

The processing circuitry of the host computer may be configured to execute a host application, thereby triggering the positioning and/or any host computer functionality described herein. Alternatively, or in addition, the processing circuitry of the UE may be configured to execute a client application associated with the host application.

Any one of the devices, the UE, the base station, the communication system or any node or station for embodying the technique may further include any feature disclosed in the context of the method aspect, and vice versa. Particularly, any one of the units and modules disclosed herein may be configured to perform or initiate one or more of the steps of the method aspect.

### BRIEF DESCRIPTION OF THE DRAWINGS

Further details of embodiments of the technique are described with reference to the enclosed drawings, wherein:

FIG. 1 shows a schematic block diagram of an embodiment of a device for (e.g., selectively) assisting SL positioning;

FIG. 2 shows a schematic block diagram of an embodiment of a device for performing a SL positioning using at least one selected assisting radio device;

FIG. 3 shows a schematic block diagram of an embodiment of a (e.g., stationary) device for performing or assisting SL positioning;

FIG. 4 shows a flowchart for a method of (e.g., selectively) assisting SL positioning, which method may be implementable by the device of FIG. 1;

FIG. 5 shows a flowchart for a method of performing SL positioning using at least one selected assisting radio device, which method may be implementable by the device of FIG. 2;

FIG. 6 shows a flowchart for a method of performing or assisting SL positioning, which method may be implementable by the device of FIG. 3;

FIG. 7A schematically illustrates a first example of a radio network comprising embodiments of the devices of FIGS. 1, 2, and 3 for performing the methods of FIGS. 4, 5, and 6, respectively;

FIG. 7B schematically illustrates a second example of a radio network comprising embodiments of the devices of FIGS. 1, 2, and 3 for performing the methods of FIGS. 4, 5, and 6, respectively;

FIG. 7C schematically illustrates a third example of a radio network comprising embodiments of the devices of FIGS. 1, 2, and 3 for performing the methods of FIGS. 4, 5, and 6, respectively;

FIG. 8 schematically illustrates a block diagram of network components for embodying the devices of FIGS. 1, 2, and 3 performing the methods of FIGS. 4, 5, and 6, respectively;

FIG. 9 schematically illustrates a signaling diagram resulting from embodiments of the devices of FIGS. 1, 2, and 3 performing the methods of FIGS. 4, 5, and 6, respectively, in radio communication;

FIG. 10A schematically illustrates a first example of assisting radio devices and a target radio device assisting and performing, respectively, SL positioning of the target radio device using the methods of FIGS. 4 and 5;

FIG. 10B schematically illustrates a second example of assisting radio devices and a target radio device assisting and performing, respectively, SL positioning of the target radio device using the methods of FIGS. 4 and 5;

FIG. 11 schematically illustrates a signaling diagram resulting from embodiments of the devices of FIGS. 1, 2, and 3 performing the methods of FIGS. 4, 5, and 6, respectively, in radio communication;

FIG. 12 schematically illustrates a data structure for implementing a control message exchanged between the at least one candidate assisting radio device and the target radio device, optionally for implementing a discovery message, which can be used in an embodiment of any one of the methods of FIGS. 4, 5, and 6;

FIG. 13 schematically illustrates a data structure for a discovery message, which can be used in an embodiment of any one of the methods of FIGS. 4, 5, and 6;

FIG. 14 shows a schematic block diagram of an assisting radio device embodying the device of FIG. 1;

FIG. 15 shows a schematic block diagram of a target radio device embodying the device of FIG. 2;

FIG. 16 shows a schematic block diagram of a core node embodying the device of FIG. 3;

FIG. 17 schematically illustrates an example telecommunication network connected via an intermediate network to a host computer;

FIG. 18 shows a generalized block diagram of a host computer communicating via a base station or radio device functioning as a gateway with a user equipment over a partially wireless connection; and

FIGS. 19 and 20 show flowcharts for methods implemented in a communication system including a host computer, a base station or radio device functioning as a gateway and a user equipment.

### DETAILED DESCRIPTION

In the following description, for purposes of explanation and not limitation, specific details are set forth, such as a specific network environment in order to provide a thorough understanding of the technique disclosed herein. It will be apparent to one skilled in the art that the technique may be practiced in other embodiments that depart from these specific details. Moreover, while the following embodiments are primarily described for a New Radio (NR) or 5G implementation, it is readily apparent that the technique described herein may also be implemented for any other radio communication technique, including a Wireless Local Area Network (WLAN) implementation according to the standard family IEEE 802.11, 3GPP LTE (e.g., LTE-Advanced or a related radio access technique such as MulteFire), for Bluetooth according to the Bluetooth Special Interest Group (SIG), particularly Bluetooth Low Energy, Bluetooth Mesh Networking and Bluetooth broadcasting, for Z-Wave according to the Z-Wave Alliance or for ZigBee based on IEEE 802.15.4.

Moreover, those skilled in the art will appreciate that the functions, steps, units and modules explained herein may be implemented using software functioning in conjunction with a programmed microprocessor, an Application Specific Integrated Circuit (ASIC), a Field Programmable Gate Array (FPGA), a Digital Signal Processor (DSP) or a general purpose computer, e.g., including an Advanced RISC Machine (ARM). It will also be appreciated that, while the following embodiments are primarily described in context with methods and devices, the invention may also be embodied in a computer program product as well as in a system comprising at least one computer processor and memory coupled to the at least one processor, wherein the memory is encoded with one or more programs that may perform the functions and steps or implement the units and modules disclosed herein.

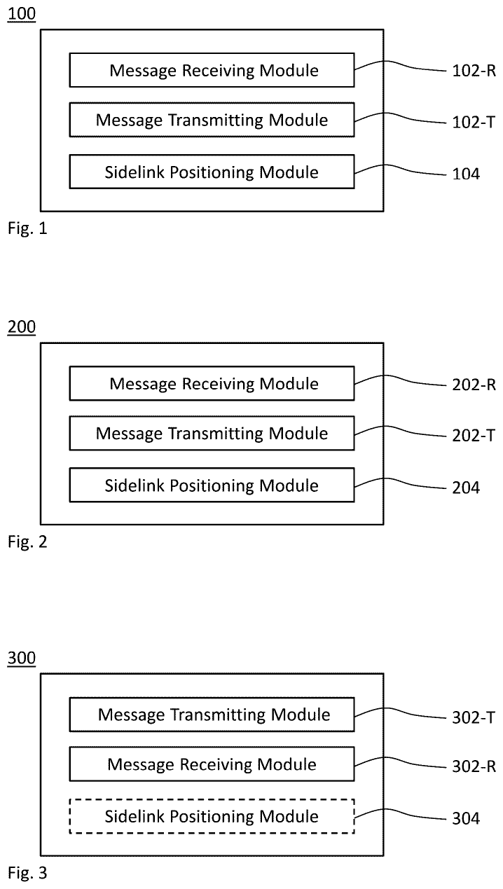

FIG. 1 schematically illustrates a block diagram of an embodiment of a device according to the first device aspect, e.g. a candidate assisting radio device 100 or assisting radio device 100, for sidelink positioning (SL positioning) of a target radio device using a SL between the target radio device and the assisting radio device 100. The device is generically referred to by reference sign 100.

The device 100 comprises modules as indicated in FIG. 1.

A Message Transmitting Module 102-T of the device 100 transmits a control message indicative of a Quality of Service (QoS) supported by the (e.g., candidate) assisting radio device (100) for the SL positioning. Alternatively or in addition, a Message Receiving Module 102-R of the device 100 receives a control message indicative of a QoS required for the SL positioning. Alternatively or in addition, a Sidelink Positioning Module assists the SL positioning as the assisting radio device, if the (e.g., candidate) assisting radio device 100 fulfills the required QoS and/or based on the supported QoS.

Any of the modules of the device 100 may be implemented by units configured to provide the corresponding functionality.

The device 100 may also be referred to as, or may be embodied by, the assisting radio device (or briefly: assistance). The assisting radio device 100 and the target radio device may be in direct radio communication. The target radio device may be embodied by the device 200.

FIG. 2 schematically illustrates a block diagram of an embodiment of a device according to the second device aspect, e.g., a target radio device 200, for sidelink positioning (SL positioning) of the target radio device 200 using a SL between the target radio device 200 and at least one assisting radio device. The device is generically referred to by reference sign 200.

The device 200 comprises modules as indicated in FIG. 2.

A Message Receiving Module 202-R of the device 200 receives a control message indicative of a Quality of Service (QoS) supported by at least one candidate assisting radio device for the SL positioning. Alternatively or in addition, a Message Transmitting Module 202-T transmits a control message indicative of a QoS required for the SL positioning. Alternatively or in addition, a Sidelink Positioning Module 204 performs the SL positioning using the at least one assisting radio device that fulfills the required QoS and/or based on the supported QoS.

Any of the modules of the device 200 may be implemented by units configured to provide the corresponding functionality.

The device 200 may also be referred to as, or may be embodied by, the target radio device (or briefly: target). The target radio device 100 and the assisting radio device may be in direct radio communication. The assisting radio device may be embodied by the device 100.

FIG. 3 schematically illustrates a block diagram of an embodiment of a device according to the third device aspect, e.g., by a node of a network (optionally by a core node of a core network), for sidelink positioning (SL positioning) of a target radio device using a SL between the target radio device and at least one assisting radio device. The device is generically referred to by reference sign 300.

The device 300 comprises modules as indicated in FIG. 3.

A Message Receiving Module 302-R of the device 300 receives a control message indicative of a Quality of Service (QoS) supported for the SL positioning from the at least one candidate assisting radio device. Alternatively or in addition, a (e.g., the afore-mentioned) Message Transmitting Module 302-R of the device 300 receives a (e.g., the afore-mentioned) control message indicative of a QoS required for the SL positioning from the target radio device (200).

Alternatively or in addition, a Message Transmitting Module 302-T of the device 300 transmits a control message indicative of a QoS supported by at least one candidate assisting radio device for the SL positioning to the at least one candidate assisting radio device. Alternatively or in addition, a (e.g., the afore-mentioned) Message Transmitting Module 302-T transmits a control message indicative of a QoS required by the target radio device for the SL positioning to the target radio device.

An optional Sidelink Positioning Module 304 of the device 300 assists or performs the SL positioning if the (e.g., candidate) assisting radio device fulfills the required QoS and/or based on the supported QoS.

Any of the modules of the device 300 may be implemented by units configured to provide the corresponding functionality.

The device 300 may also be referred to as, or may be embodied by, the core node (or briefly: node). The target radio device and/or the assisting radio device may be in direct radio communication with the device 300.

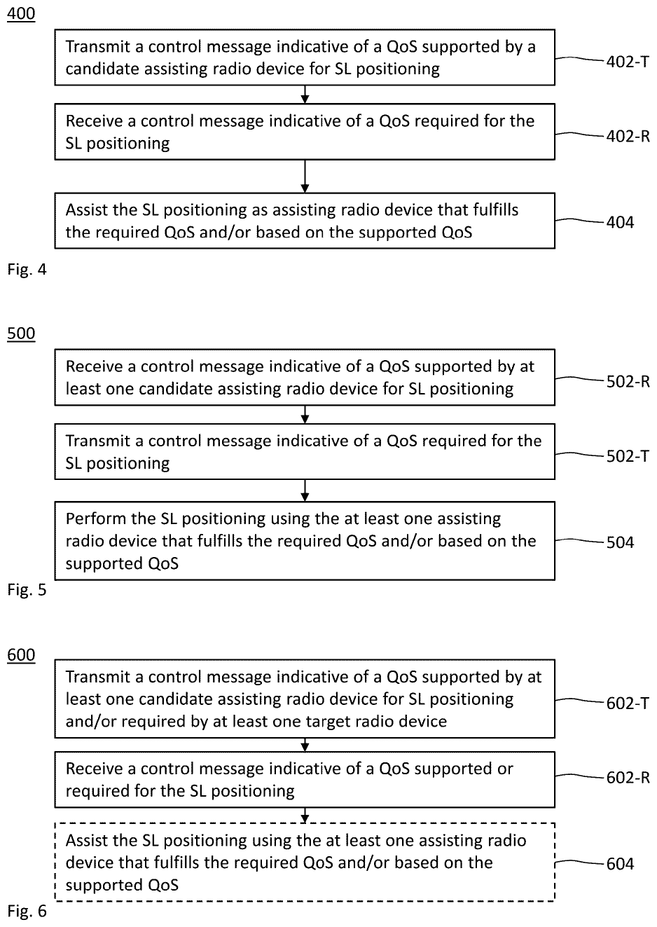

FIG. 4 shows an example flowchart for a method 400 according to the first method aspect, e.g. performed by a candidate assisting radio device or assisting radio device, for sidelink positioning (SL positioning) of a target radio device using a SL between the target radio device and the assisting radio device.

The method 400 comprises at least one of the steps indicated in FIG. 4.

In a step 402-T, a control message indicative of a Quality of Service (QoS) supported by the candidate assisting radio device for the SL positioning is transmitted. Alternatively or in addition, in a step 402-R A control message indicative of a QoS required for the SL positioning is received. Alternatively or in addition, in a step 404 of the method 400, the SL positioning is assisted as the assisting radio device, if the candidate assisting radio device fulfills the required QoS and/or based on the supported QoS.

The method 400 may be performed by the device 100. For example, the modules 102-R, 102-T, and 104 may perform the steps 402-R, 402-T, and 404, respectively.

FIG. 5 shows an example flowchart for a method 500 according to the first method aspect, e.g. performed by a target radio device, for sidelink positioning (SL positioning) of the target radio device using a SL between the target radio device and at least one assisting radio device.

The method 500 comprises at least one of the steps indicated in FIG. 5.

In a step 502-R (which may be implemented according to the examples 502-R1, 502-R2, or 502-R3 below) of the method 500, a control message indicative of a Quality of Service (QoS) supported by at least one candidate assisting radio device for the SL positioning is received. Alternatively or in addition, in a step 502-T (which may be implemented according to any of the examples 502-T1, 502-T2, or 502-T3) of the method 500, a control message indicative of a QoS required for the SL positioning is transmitted. Alternatively or in addition, the SL positioning is performed using the at least one assisting radio device that fulfills the required QoS and/or based on the supported QoS.

The method 500 may be performed by the device 200. For example, the modules 202-R, 202-T, and 204 may perform the steps 502-R, 502-T, and 504, respectively.

FIG. 6 shows an example flowchart for a method 600 according to the first method aspect, e.g., performed by a node of a network (optionally by a core node of a core network), for sidelink positioning (SL positioning) of a target radio device using a SL between the target radio device and at least one assisting radio device.

The method 600 comprises at least one of the steps indicated in FIG. 6. In a step 602-R of the method 600, a control message indicative of a Quality of Service (QoS) supported for the SL positioning from the at least one candidate assisting radio device is received. Alternatively or in addition, in a (or the afore-mentioned) step 602-R, a control message indicative of a QoS required for the SL positioning from the target radio device is received. Alternatively or in addition, in a step 602-T, a (e.g., the afore-mentioned) control message indicative of a QoS supported by at least one candidate assisting radio device for the SL positioning to the at least one candidate assisting radio device is transmitted. Alternatively or in addition, in a step 602-T, a control message indicative of a QoS required by the target radio device for the SL positioning to the target radio device is transmitted.

Optionally, in step 604, the SL positioning is assisted or performed using the at least one assisting radio device that fulfills the required QoS and/or based on the supported QoS.

The method 600 may be performed by the device 300. For example, the modules 302-R, 302-T, and 304 may perform the steps 602-R, 602-T, and 604, respectively.

In any aspect, the technique may be applied to uplink (UL), downlink (DL) or direct communications between radio devices, e.g., device-to-device (D2D) communications or sidelink (SL) communications.

Each of the assisting radio device 100 and the target radio device 200 may be a radio device. Herein, any radio device may be a mobile or portable station and/or any radio device wirelessly connectable to a base station or RAN, or to another radio device. For example, the radio device may be a user equipment (UE), a device for machine-type communication (MTC) or a device for (e.g., narrowband) Internet of Things (IoT). Two or more radio devices may be configured to wirelessly connect to each other, e.g., in an ad hoc radio network or via a 3GPP SL connection. Furthermore, any base station may be a station providing radio access, may be part of a radio access network (RAN) and/or may be a node connected to the RAN for controlling the radio access. For example, the base station may be an access point, for example a Wi-Fi access point.

Herein, whenever referring to noise or a signal-to-noise ratio (SNR), a corresponding step, feature or effect is also disclosed for noise and/or interference or a signal-to-interference-and-noise ratio (SINR).

Positioning and/or ranging, which is also referred to as location services (LCS) or collectively as positioning, have been a topic in the standardization of fourth generation (4G) radio access technology (RAT) such as Long Term Evolution (LTE) since 3GPP Release 9.

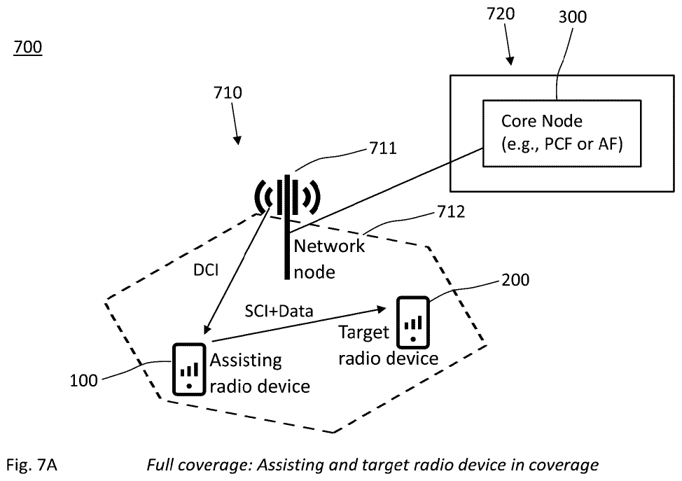

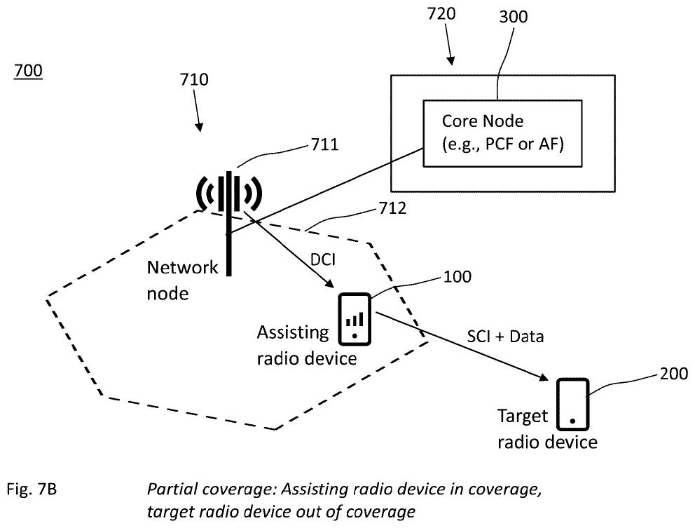

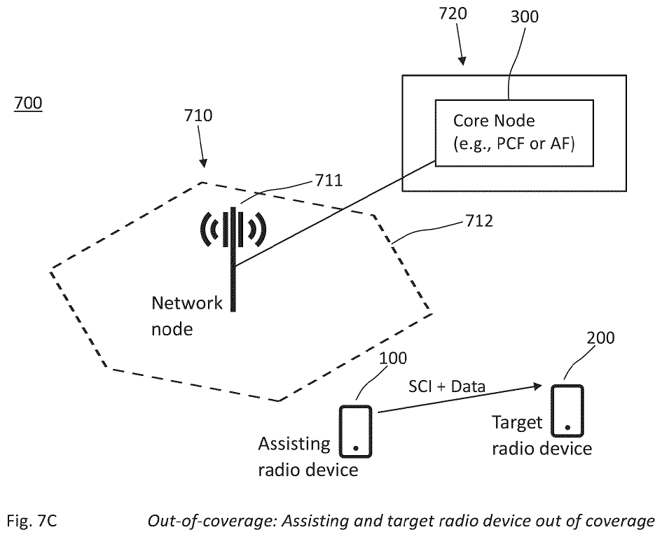

FIGS. 7A, 7B, and 7C schematically illustrate SL positioning for a target radio device 200 (e.g., a UE) in different coverage scenarios. In FIGS. 7A, 7B, and 7C, the assisting radio device 100 (e.g., assisting UE), which may also be referred to as the reference radio device (or reference UE), provides SL measurement assistance to the target radio device 200.

While the subject technique may use the SL (i.e., the PC5 interface) for SL positioning, conventional positioning uses an interface between a network node 711 (e.g., a gNodeB) of a radio access network 710 (RAN) and a radio device 100 or 200 (e.g., a 3GPP user equipment, UE) such as a Uu interface.

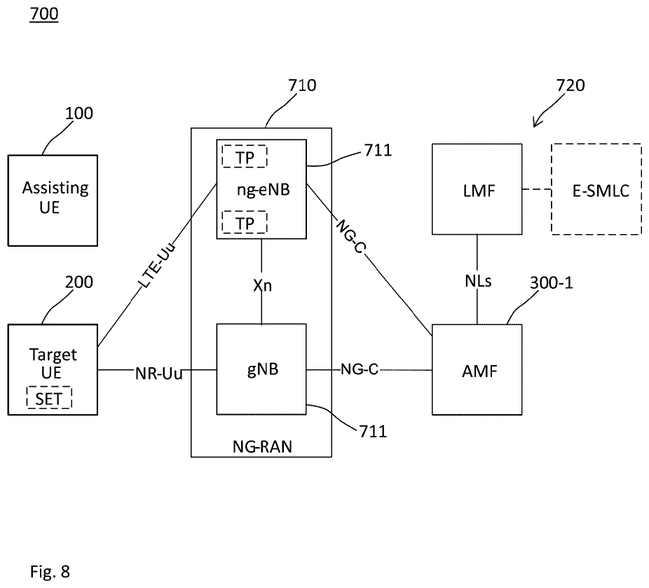

A primary objective is to fulfill regulatory requirements for emergency call positioning. Positioning in fifth generation (5G) RAT such as 3GPP New Radio (NR) has been proposed to be supported by the architecture shown in FIG. 8.

A location management function (LMF) is the location node in a NR system. There are also interactions between the location node and the gNodeB via a NR positioning protocol A (NRPPa). The interaction between the gNodeB and the radio device is supported via a Radio Resource Control (RRC) protocol.

FIG. 8 schematically illustrates a block diagram comprising NG-RAN Release 15 LCS Protocols (e.g., units or nodes implementing such protocols). Each network node 711 may comprise one or more Transmission Points (TPs).

At least one of the at least one assisting radio UE 100, the target radio device 200, and the core node 300-1 is modified to embody the respective one of the device 100, 200, and 300.

The gNodeB (gNB) 711 and an eNodeB (eNB) 711 that is connected to Xn and NG (which is called ng-eNB) may or may not always both be present. Alternatively or in addition, when both the gNB 711 and ng-eNB 711 are present, the NG-C interface may be only present for one of them.

In existing LTE standards, the following techniques are supported. Any embodiment may use any one of the LTE techniques for positioning, also in an analogous manner for the SL positioning (e.g., wherein one of the assisting UE and target UE assumes a role similar to a network node 711 as far as the positing is concerned).

Enhanced Cell ID (E-CID) may encompass essentially cell ID information to associate the radio device to a serving area of a serving cell, and optionally additional information to determine a finer granularity position.

For assisted global navigation satellite system (GNSS), GNSS information may be retrieved by a radio device and supported by assistance information provided to the radio device from an enhanced or evolved Serving Mobile Location Center (E-SMLC).

For Observed Time Difference of Arrival (OTDOA), radio device may estimate a time difference of reference signals from different base stations and transmit the time difference to the E-SMLC for multilateration.

For Uplink TDOA (UTDOA or UL-TDOA), a radio device is requested to transmit a specific waveform that is detected by multiple location measurement units (e.g. network nodes such as eNBs) at known positions. These measurements are forwarded to E-SMLC for multilateration.

Sensor techniques such as a (e.g., biometric) pressure sensor which is indicative of a vertical position of the radio device and/or an Inertial Motion Unit (IMU) which is indicative of (e.g., relative or integrable) displacements.

Alternatively or in addition, any embodiment may use any one of the 3GPP NR methods or RAT-dependent methods for positioning. Alternatively or in addition, any embodiment may use at least one of the following positioning methods, also in an analogous manner for the SL positioning (e.g., wherein one of the assisting ULE 100 and target UE 200 assumes a role similar to a network node 711 as far as the positing is concerned).

Downlink TDOA (DL-TDOA) DL TDOA positioning method makes use of the DL RSTD (and optionally DL PRS RSRP) of downlink signals received from multiple (Transmission Points) TPs, at the UE. The UE measures the DL RSTD (and optionally DL PRS RSRP) of the received signals using assistance data received from the positioning server, and the resulting measurements are used along with other configuration information to locate the UE in relation to the neighboring TPs.

Multi-Round-Trip-Time (Multi-RTT) positioning method makes use of the UE Rx-Tx measurements. Alternatively or in addition, multi-RTT positioning may make use of reference signal received power (RSRP) of downlink (DL) signals, e.g. downlink positioning reference signal (DL PRS) RSRP of downlink signals received from multiple Transmission Reception Points (TRPs) measured by the UE. Alternatively or in addition, multi-RTT positioning may make use of measured gNB Rx-Tx measurements and/or the RSRP of uplink (UL) signals such as an UL sounding reference signals (SRS)-RSRP at multiple TRPs of uplink signals transmitted from UE.

UL-TDOA positioning method makes use of the UL TDOA (and optionally UL SRS-RSRP) at multiple Reception Points (RPs) of uplink signals transmitted from UE. The RPs measure the UL TDOA (and optionally UL SRS-RSRP) of the received signals using assistance data received from the positioning server, and the resulting measurements are used along with other configuration information to estimate the location of the UE.

Downlink Angle of Departure (DL-AoD) positioning method makes use of the measured DL PRS RSRP of downlink signals received from multiple TPs, at the UE. The UE measures the DL PRS RSRP of the received signals using assistance data received from the positioning server, and the resulting measurements are used along with other configuration information to locate the UE in relation to the neighboring TPs.

Uplink Angle of Arrival (UL-AoA) positioning method makes use of the measured azimuth (A) and zenith (Z) of arrival at multiple RPs of uplink signals transmitted from the UE. The RPs measure A-AoA and Z-AoA of the received signals using assistance data received from the positioning server, and the resulting measurements are used along with other configuration information to estimate the location of the UE.

NR Enhanced Cell ID (NR E-CID or NR-ECID) positioning refers to techniques which use additional UE measurements and/or NR radio resource and other measurements to improve the UE location estimate.

Alternatively or in addition, any embodiment may use at least one of the following three modes of the positioning (which may also be referred to as positioning mode category).
UE-Assisted mode: The radio device (e.g., UE) performs measurements with or without assistance from a network (e.g., one or more network nodes of a RAN) and sends these measurements to the E-SMLC. The E-SMLC may determine (e.g., compute) the position.
UE-Based mode: The radio device (e.g., UE) performs measurements and determines (e.g., computes) its own position with assistance from the network (e.g., one or more network nodes of the RAN).
Standalone mode: The radio device (e.g., UE) performs measurements and determines (e.g., computes) its own position without assistance from the network.

Any embodiment may use at least one of the following features of sidelink (SL) transmissions, e.g. according to 3GPP NR. Sidelink transmissions over NR are specified for Release 16. These are enhancements of the ProSe (PROximity-based SErvices) specified for LTE. Four new enhancements are particularly introduced to NR sidelink transmissions as follows:
Support for unicast and groupcast transmissions are added in NR sidelink. For unicast and groupcast, the physical sidelink feedback channel (PSFCH) is introduced for a receiver UE to reply the decoding status to a transmitter UE.
Grant-free transmissions, which are adopted in NR uplink transmissions, are also provided in NR sidelink transmissions, to improve the latency performance.
To alleviate resource collisions among different sidelink transmissions launched by different UEs, it enhances channel sensing and resource selection procedures, which also lead to a new design of PSCCH.
To achieve a high connection density, congestion control and thus the QoS management is supported in NR sidelink transmissions.

To enable the above enhancements, alternative or additional physical channels and/or reference signals (RSs) are introduced in NR (available in LTE before.):
PSSCH (Physical Sidelink Shared Channel, SL version of PDSCH): The PSSCH is transmitted by a sidelink transmitter UE, which conveys sidelink transmission data, system information blocks (SIBs) for radio resource control (RRC) configuration, and a part of the sidelink control information (SCI).
PSFCH (Physical Sidelink, SL version of PUCCH): The PSFCH is transmitted by a sidelink receiver UE for unicast and groupcast, which conveys 1 bit information over 1 RB for the HARQ acknowledgement (ACK) and the negative ACK (NACK). In addition, channel state information (CSI) is carried in the medium access control (MAC) control element (CE) over the PSSCH instead of the PSFCH.
PSCCH (Physical Sidelink Common Control Channel, SL version of PDCCH): When the traffic to be sent to a receiver UE arrives at a transmitter UE, a transmitter UE should first send the PSCCH, which conveys a part of SCI (Sidelink Control information, SL version of DCI) to be decoded by any UE for the channel sensing purpose, including the reserved time-frequency resources for transmissions, demodulation reference signal (DMRS) pattern and antenna port, etc.
Sidelink Primary/Secondary Synchronization Signal (S-PSS/S-SSS): Similar to downlink transmissions in NR, in sidelink transmissions, primary and secondary synchronization signals (called S-PSS and S-SSS, respectively) are supported. Through detecting the S-PSS and S-SSS, a UE is able to identify the sidelink synchronization identity (SSID) from the UE sending the S-PSS/S-SSS. Through detecting the S-PSS/S-SSS, a UE is therefore able to know the characteristics of the UE transmitter the S-PSS/S-SSS. A series of process of acquiring timing and frequency synchronization together with SSIDs of UEs is called initial cell search. Note that the UTE sending the S-PSS/S-SSS may not be necessarily involved in sidelink transmissions, and a node (UE/eNB/gNB) sending the S-PSS/S-SSS is called a synchronization source, There are 2 S-PSS sequences and 336 S-SSS sequences forming a total of 672 SSIDs in a cell.
Physical Sidelink Broadcast Channel (PSBCH): The PSBCH is transmitted along with the S-PSS/S-SSS as a synchronization signal/PSBCH block (SSB). The SSB has the same numerology as PSCCH/PSSCH on that carrier, and an SSB should be transmitted within the bandwidth of the configured BWP, The PSBCH conveys information related to synchronization, such as the direct frame number (DFN), indication of the slot and symbol level time resources for sidelink transmissions, in-coverage indicator, etc. The SSB is transmitted periodically at every 160 ms.
DMRS, phase tracking reference signal (PT-RS), channel state information reference signal (CSIRS): These physical reference signals supported by NR downlink/uplink transmissions are also adopted by sidelink transmissions. Similarly, the PT-RS is only applicable for FR2 transmission.

Moreover, any embodiment may use a two-stage sidelink control information (SCI), e.g., as a feature of 3GPP NIR. SCI may be a version of the downlink control information (DCI) for the SL. Unlike the DCI, only part (i.e., a first stage) of the SCI is sent on the PSCCH. This part is used for channel sensing purposes (e.g., including the reserved time-frequency resources for transmissions, demodulation reference signal (DMRS) pattern and antenna port, etc.) and can be read by all UEs while the remaining (i.e., a second stage) scheduling and control information such as a 8-bits source identity (ID) and a 16-bits destination ID, NDI, RV and HARQ process ID is sent on the PSSCH to be decoded by the receiver UE.

Any embodiment may use, e.g. as a feature of ProSe in LTE and/or as a feature of NR sidelink, for SL transmissions at least one of the following two modes of resource allocations: In Mode 1, sidelink resources are scheduled by a (e.g., serving) network node (gNB or eNB). In Mode 2, the UE autonomously selects sidelink resources from a (pre-)configured sidelink resource pool(s) based on the channel sensing mechanism.

For the in-coverage UE, a gNB can be configured to adopt Mode 1 or Mode 2. For the out-of-coverage UE, only Mode 2 can be adopted.

In LTE or NR, scheduling over the sidelink may be performed in different ways for Mode 1 and Mode 2. Mode 1 supports the following two kinds of grants.

Dynamic grant: When the traffic to be sent over sidelink arrives at a transmitter UE, this UE should launch the four-message exchange procedure to request sidelink resources from a gNB (SR on UL, grant, BSR on UL, grant for data on SL sent to UE). During the resource request procedure, a gNB may allocate a sidelink radio network temporary identifier (SL-RNTI) to the transmitter UE. If this sidelink resource request is granted by a gNB, then a gNB indicates the resource allocation for the PSCCH and the PSSCH in the downlink control information (DCI) conveyed by PDCCH with CRC scrambled with the SL-RNTI When a transmitter UE receives such a DCI, a transmitter UE can obtain the grant only if the scrambled CRC of DCI can be successfully solved by the assigned SL-RNTI A transmitter UE then indicates the time-frequency resources and the transmission scheme of the allocated PSSCH in the PSCCH, and launches the PSCCH and the PSSCH on the allocated resources for sidelink transmissions. When a grant is obtained from a gNB, a transmitter UE can only transmit a single TB, As a result, this kind of grant is suitable for traffic with a loose latency requirement.

Configured grant: For the traffic with a strict latency requirement, performing the four-message exchange procedure to request sidelink resources may induce unacceptable latency. In this case, prior to the traffic arrival, a transmitter UE may perform the four-message exchange procedure and request a set of resources. If a grant can be obtained from a gNB, then the requested resources are reserved in a periodic manner. Upon traffic arriving at a transmitter UE, this UE can launch the PSCCH and the PSSCH on the upcoming resource occasion. In fact, this kind of grant is also known as grant-free transmissions.

In both dynamic grant and configured grant, a sidelink receiver UE cannot receive the DC (since it is addressed to the transmitter UE), and therefore a receiver UE should perform blind decoding to identify the presence of PSCCH and find the resources for the PSSCH through the SCI.

When a transmitter UE 100 or 200 launches the PSCCH, a cyclic redundancy check (CRC) may be inserted in the SCI without any scrambling.

When referring to a UE hereinbelow, the disclosure may be applied to the assisting UE 100 and/or the target UE 200.

Any embodiment may use ProSe Service Authorization and Provisioning to UE. For example ProSe Service Authorization may be implemented considering the 3GPP document TS 23.304, version 18.0.0. The procedures for service authorization and provisioning to UE may be initiated by a policy control function (PCF), by the radio device (e.g., UE), or by an application function (AF, e.g., a functional element that provides service- or application-related information to NF service consumers).

For example, any embodiment may use PCF-based Service Authorization and Provisioning to UE. For PCF-based Service Authorization and Provisioning to UE, the Registration procedures as defined in clause 4.2.2.2 of the 3GPP document TS 23.502, version 18.0.0; and/or UE Policy Association Establishment procedure as defined in clause 4.16.11 of the 3GPP document TS 23,502, version 18.0.0, and/or UE Policy Association Modification procedure as defined in clause 4.16.12 of the 3GPP document TS 23.502, version 18.0.0, apply. Alternatively or in addition, PCF-based Service Authorization and Provisioning to UE may comprise at least one of the following steps:
If the UE indicates 5G ProSe Capability in the Registration Request message and if the UE is authorized to use 5G ProSe service based on subscription data, the AMF selects the PCF which supports 5G ProSe policy and/or parameter provisioning (e.g., as described in clause 6.2.3 of the 3GPP document TS 23.502) and establishes a UE policy association with the PCF for 5G ProSe policy and/or parameter delivery.
If the UE supports one of 5G ProSe capabilities and it does not have valid 5G ProSe policy and/or parameters, the UE includes a UE policy container with indicating a 5G ProSe policy provisioning request during registration procedure. The UE may also include UE capabilities as defined in clause 4.3.1 in the 5G ProSe policy provisioning request and PCF may determine the ProSe policy and/or parameters for the UE based on received UE capabilities.
If the UE indicates the 5G ProSe policy provisioning request in the UE policy container, the PCF determines whether to provision 5G ProSe policy and/or parameters to the UE, e.g. as specified in clause 6.1.2.2.2 of the 3GPP document TS 23.503, version 18.0.0; and the PCF provides the 5G ProSe policy and/or parameters (e.g. as specified in clause 5.1.2.1, clause 5.1.3.1 and clause 5.1.4.1 of the 3GPP document TS 23.503, version 18.0.0) to the UE (e.g., by using the procedure as defined in clause 4.2.4.3 “UE Configuration Update procedure for transparent UE Policy Delivery” in the 3GPP document TS 23.502, version 18.0.0).

In any embodiment, the radio device 100 or 200 (e.g., UE) may perform a UE-triggered policy provisioning procedure to the PCF (e.g. as specified in clause 6.2.4 of the 3GPP document TS 23.502, version 18.0.0) when the UE determines the 5G ProSe policy and/or parameters are invalid (e.g., the policy and/or parameter is outdated, missing or invalid).

When the UE 100 or 200 disables a ProSe capability, the PCF may stop updating the corresponding ProSe policy and/or parameter(s). Alternatively or in addition, when the UE enables, a ProSe capability the PCF may need to provide or update the corresponding ProSe policy and/or parameter(s).

Any embodiment may comprise a procedure for UE-triggered ProSe policy provisioning. The UE-triggered policy provisioning procedure may be initiated by the UE to request ProSe policy and/or parameters from the PCF, e.g. when the UE 100 or 200 determines the 5G ProSe policy and/or parameters is invalid, e.g. in at least one of the following cases:
if the validity timer indicated in the 5G ProSe policy and/or parameter expires;
if there are no valid parameters, e.g. for the 5G ProSe identifier a UE wants to use, for current area, or due to abnormal situation.

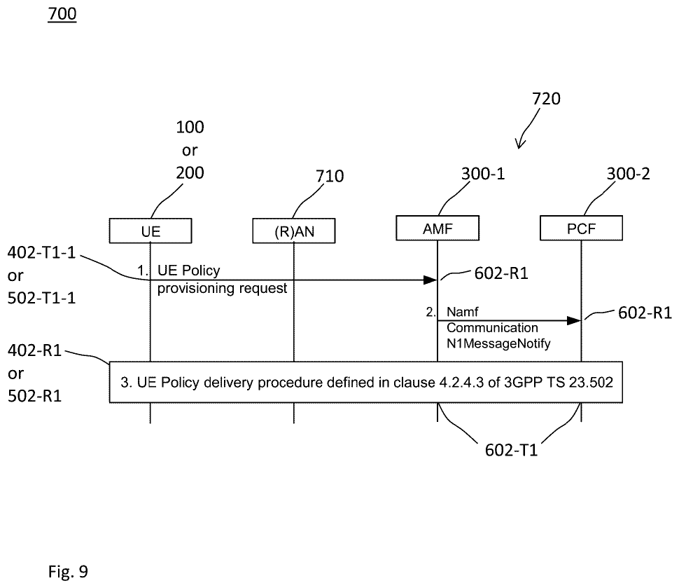

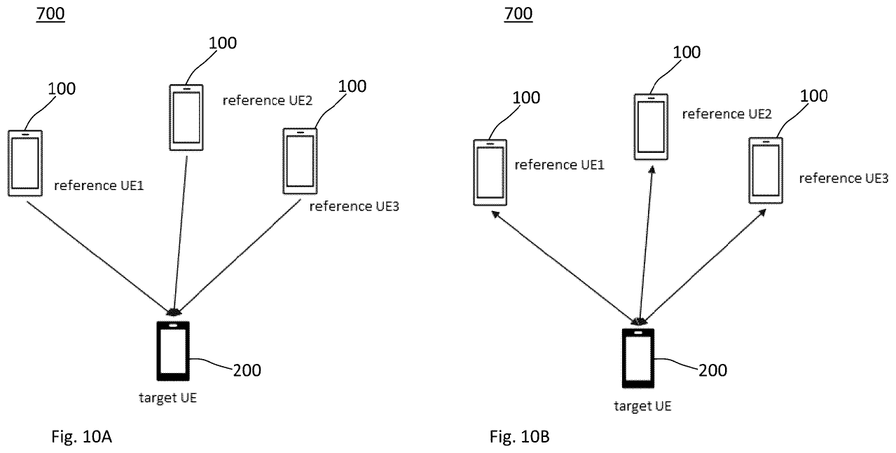

FIG. 9 schematically illustrates a signaling diagram (which may a corresponding procedure) for UE-triggered 5G ProSe Policy provisioning. “Namf” may relate to a 3GPP 5G architecture. It may comprise a service-based interface for a core Access and Mobility Management Function (AMF).

The AMF may send a message, e.g., according to a Namf_Communication_N1MessageNotify service operation specified in the 3GPP document TS 29.518, version 18.0.0, to send a “MANAGE UE POLICY COMPLETE” message or a “MANAGE UE POLICY COMMAND REJECT” message, as defined in Annex D.5 of the 3GPP document TS 24.501, version 18.1.0, to the VPCF.

The procedure for UE-triggered ProSe policy provisioning may comprise at least one of the following three steps, e.g., as indicated in FIG. 9.

In a step 1, the UE sends an UL NAS TRANSPORT message carrying the UE policy container (e.g., a UE policy provisioning request to request 5G ProSe policies) to the AMF.

In a step 2, the AMF sends Namf_Communication_N1MessageNotify request to the PCF including the UE Policy Container received from UE.

In a step 3, the PCF receives UE Policy Container which indicates UE Policy Provisioning Request to request 5G ProSe policies. If the 5G ProSe policies are authorized based on AMF input, the PCF performs the UE Policy delivery procedure as defined in clause 4.2.4.3 of 3GPP document TS 23.502, version 18.0.0.

The step 1 may be modified according to the transmitting step 402-T1-1 or 502-T1-1 of the first or second method aspect 400 and 500, respectively. Alternatively or in addition, the step 3 may be modified according to the receiving step 402-R1 or 502-R1 of the first or second method aspect 400 and 500, respectively.

Alternatively or in addition, any embodiment may comprise an AF-based service parameter provisioning for ProSe over control plane (CP). For example, for 5G ProSe service parameter provisioning (i.e. creating, updating and deleting), the procedure defined in clause 4.15.6.7 of 3GPP document TS 23.502, version 18.0.0, is performed, e.g. with the at least one of the following considerations:
The AF in the 3GPP document TS 23.502, version 18.0.0, is considered as ProSe Application Server in this specification.
Service description indicates 5G ProSe service domain information.
Service parameters include parameters for 5G ProSe Direct Discovery and 5G ProSe Direct Communications. The detailed information on the parameters is described in clause 5.1.2.1 and clause 5.1.3.1.
Service Parameters for 5G ProSe UE-to-Network Relay Discovery and 5G ProSe UE-to-Network Relay Communications. The detailed information on the parameters is described in clause 5.1.4.1.

The ProSe service domain information may be set based on a Service Level Agreement with the operator.

Any embodiment may implement at least one of the following features for SL discovery, e.g., ProSe Direct Discovery, and/or any feature on ProSe Direct Discovery in the 3GPP document TS 23.303, version 17.0.0. The following models for ProSe Direct Discovery exist:

Model A (“I am here”)

This model A defines two roles for the ProSe-enabled UEs that are participating in ProSe Direct Discovery.
Announcing UE 100 or 200: The LUE announces certain information that could be used by UEs in proximity that have permission to discover.
Monitoring UE 200 or 100: The UE that monitors certain information of interest in proximity of announcing UEs.

In this model the announcing UE broadcasts discovery messages at pre-defined discovery intervals and the monitoring UEs that are interested in these messages read them and process them.

Model B (“Who is there?” or “Are you there?”)

This model B when restricted discovery type is used, defines two roles for the ProSe-enabled UEs that are participating in ProSe Direct Discovery.
Discoverer UE 100 or 200: The UE transmits a request containing certain information about what it is interested to discover.
Discoveree UE 200 or 100: The UE that receives the request message can respond with some information related to the discoverer's request.

It is equivalent to “who is there” and/or “are you there”, since the discoverer UE sends information about other UEs that would like to receive responses from, e.g. the information can be about a ProSe Application Identity (also referred to as application identifier or application ID), e.g. corresponding to a group and the members of the group can respond.

In any embodiment, the positioning may be SL-based positioning, e.g. according to 3GPP Release 18. In 3GPP Release 18, SL positioning is being studied.

At least some embodiments may meet a study objective, which has been defined in the 3GPP document RP-213561 regarding SL positioning protocol architecture and signaling procedures. Alternatively or in addition, at least some embodiments may enable a positioning architecture and signaling procedures (e.g. configuration, measurement reporting, etc.) that comprises both UE-based and network-based positioning.

Alternatively or in addition, the technique may be applied or performed for the UE (i.e., the target UE which needs to be positioned) in various scenarios with different network coverage, including full coverage, partial coverage and out-of-coverage, e.g., as shown in FIGS. 7A, 7B, and 7C, respectively.

Herein, for concreteness and without limitation, radio devices are referred to as UEs.

For a target UE out of coverage, there may be different options for the target UE 200 to get positioned. In one option, the target UE 200 may choose to connect to the network 300 via a SL U2N relay UE 100. In this case, the network 300 can be involved in the positioning procedure for the target UE 200. In another option, the target UE 200 may apply UE-based positioning by involving an assisting UE 100, If there is not any assisting UE 100 found in the proximity, the target UE 200 can reach an assisting UE 100 in further range via a U2U relay UE 100′. The assisting UE 100 may also be referred as reference UE or anchor UE.

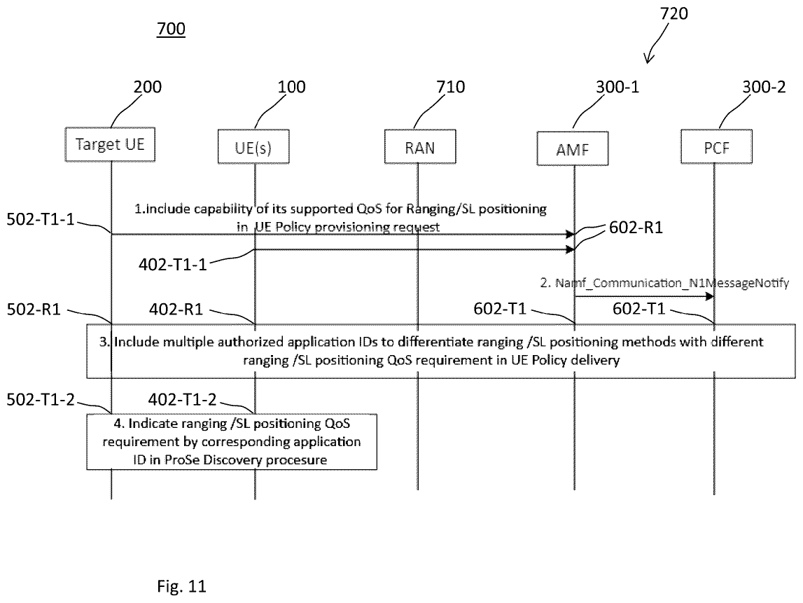

Any one of the positioning methods disclosed herein (e.g., also existing positioning methods for the Uu interface), e.g. including DL-TDOA, UL-TDOA, and Multi-RTT etc., may be applied for SL-based positioning. For example, DL and UL may be replaced by SL transmissions to and from the target UE 200, respectively. For these methods, one or multiple assisting UEs 100 (i.e., reference UEs 100) may be required, e.g., as is schematically illustrated in FIGS. 10A and 11B.

For SL-based positioning, certain method such as TDOA may require tight (i.e., precise) synchronization among multiple assisting UEs 100 (i.e., reference UEs) so that the transmissions of positioning reference signals (PRSs) from these reference UEs 100 can arrive at the target UE 200 in synchronized fashion. This can improve both positioning accuracy and avoid interference among reference UEs 200,

FIGS. 10A and 11B schematically illustrates SL positioning and ranging, e.g. using TDOA and Multi-RTT, respectively.

At least some embodiments can address at least some of the following problems.

Depending on the use case, the sessions for SL positioning and/or SL ranging are imposed with different positioning QoS requirements, Such QoS requirements would further require the selected assisting UEs to be capable of providing SL transmissions or receptions according to the QoS requirement for the corresponding sessions or services for SL positioning and/or SL ranging.

Selection and reselection of assisting UEs are expected to reuse the existing SL discovery procedures. However, the existing SL discovery procedures have the following deficiencies.

Firstly, in the current ProSe Discovery process for SL positioning and/or SL ranging, there is no mechanism to support indicating a QoS requirement for positioning. As an example, a SL UE (e.g., target UE) cannot indicate the QoS requirements of the SL positioning services and/or sessions to its neighbor UEs (e.g., potential assisting UEs). Without such information, its neighbor UEs would not be able to decide whether they fulfill the QoS requirements of the SL positioning for sessions and/or services. A neighbor UE which is not suitable may provide a discovery response message to the target UE by mistake (i.e., a wrong selection, e.g., leading to a wrong selection of an assisting UE). The target UE may therefore select this neighbor UE as one assisting UE by mistake (wrongly). As a second example, a candidate assisting UE cannot indicate the QoS requirements of the SL positioning services and/or sessions that the assisting UE can provide to its neighbor UEs (e.g., potential target UEs). Without such information, a neighbor target UE may select this assisting UE for a SL positioning session/service for which this assisting UE cannot fulfil the corresponding QoS requirements.

Secondly, there is no mechanism in the existing SL discovery procedures based on which a UE 200 can determine whether itself or a neighbor UE 100 can provide or be involved in a SL positioning session and/or service according to the QoS requirements of the SL positioning session and/or service.

In a first embodiment, e.g. of the method 400, QoS support for SL positioning and/or SL ranging is added in a UE capability (e.g., of an assisting UE or a candidate assisting UE 100). The UE capability may be sent for service authorization. For example, one or more service authorized parameters (e.g., an application ID) may be differentiated for different QoS requirements of the SL positioning, e.g. according to a first embodiment of the method 600 or a first embodiment of a device 300. The QoS requirements may be used in a ProSe discovery process (e.g., by the target UE 200) to select one or more suitable assisting UEs, e.g. according to a first embodiment of the method 500.

For the first embodiment, e.g. of the method 400, a UE 100 may include its QoS support for SL positioning and/or SL ranging in the UE capability and send the UE capability for service authorization, e.g., to a policy control function (PCF) as an embodiment of the device 300. For example, the device 300 or the method 600 for the PCF in a core network (CN) may provide different application IDs to differentiate SL positioning and/or SL ranging with different QoS requirements of the SL positioning and/or SL ranging.

In a second embodiment, a (e.g., target) UE performs a (e.g., legacy) ProSe discovery procedures, followed by exchanging QoS requirement for positioning. The QoS requirement may be exchanged using ProSe communication. The (target) UE replies to select one or more suitable assisting UEs.

For the second embodiment, after ProSe discovery, a UE 100 or 200 may exchange QoS requirement (i.e., an indicator of the QoS required for the SL positioning) and/or QoS support (i.e., an indicator of the QoS supported for the SL positioning), e.g., using ProSe or SL communication. Alternatively or in addition, the UE 200 may reply to select one or more suitable assistance (i.e., assisting) UEs 100. Alternatively or in addition, the UE 100 may selectively reply to the target UE 200 if the UE 100 can fulfil the QoS requirement.

In a third embodiment, a (e.g., target) UE 200 indicates a QoS requirement for SL positioning and/or SL ranging in a ProSe Discovery message.

In the third mechanism, the method may be distinct by being indicative of the QoS requirement for SL positioning and/or SL ranging in the ProSe Discovery message.

Detailed embodiments and options, which may be implemented as disclosed hereinbelow or in combination with any of the embodiments in the list of embodiments, are described, in part with reference to the drawings.

The assisting UE 100 may also be referred as reference UE or anchor UE.

The technique may be implemented using at least one of the following three main options.

To perform SL positioning and/or SL ranging, the target UE 200 may need to perform a ranging procedure or other positioning methods i.e., TDOA-like and multi-RTT with one or more assisting UEs 100. If such assisting UEs 100 are not available, the target UEs 100 need to perform ProSe Discovery to find assisting UEs.

To indicate QoS requirement of SL positioning and/or SL ranging, below three main options can be implemented.

A main option 1 may comprise at least one of the following features, optionally in combination with steps referred to by “-T1” and “-R1”.

The UE 100 includes capability of its supported QoS for ranging and/or SL positioning in the Registration Request message (e.g., according to the step 402-T1-1 of the method 400). The AMF (e.g. embodying the core node performing the corresponding method 600) stores this information for a ranging and/or SL positioning operation.
In one embodiment, the capability of supported QoS for ranging and/or SL positioning is indicated as the Horizontal Accuracy, Vertical Accuracy (for different ranging and SL positioning methods), Response Time (for different UE role, i.e., target UE, assisting UE, or SL UE server), etc.
In another embodiment, the capability of supported QoS for ranging and/or SL positioning is indicated as PQI like QoS, e.g., use a PQI value to indicate the maximum bandwidth to transmit SL-PRS, response time, packet delay budget and packet error rate for sending measurement report, etc.

If the UE 100 does not have valid authorization and policy/parameters for ranging and/or SL positioning, the UE 100 includes the UE Policy Container with indicating the Policy Provisioning Request for ranging and/or SL positioning during registration procedure.

If the UE 100 indicates the Policy Provisioning Request for ranging and/or SL positioning in the UE Policy Container, the PCF (which may perform the corresponding method 600) determines whether to provision the policy and/or parameters (which may be an example of the policy) for ranging and/or SL positioning to the U E 100 (e.g., as specified in clause 6.1.2.2.2 of 3GPP document TS 23.503, version 18.0.0). Alternatively or in addition, the PCF provides the policy and/or parameters for ranging and/or SL positioning to the ULE (e.g., by using the procedure as defined in clause 4.2.4.3 “UE Configuration Update procedure for transparent UE Policy Delivery” in 3GPP document TS 23.502, version 18.0.0). The PCF-provided provision of policy and/or parameters may include multiple authorized application IDs to differentiate ranging and/or SL positioning methods with different ranging and/or SL positioning QoS requirement, and optional ranging and/or SL positioning parameters for each authorized application ID. Application ID can be used as the ProSe identifier in 5G ProSe Direct Discovery and in a consequent 5G ProSe Direct Communication.

In the ProSe discovery procedure, the target UE 200 may announce discovery request using the authorized application ID to indicate the QoS requirement for ranging and/or SL positioning (e.g., according to the step 502-T1-2 of the method 500), e.g. while the assisting UE 100 may monitor the application ID in the discovery request (e.g., according to the step 402-R1 of the method 400) and only respond if it is authorized to that application ID, i.e., it supports the requirement for that ranging and/or SL positioning method (e.g., according to the step 404 of the method 400). Each of the one or more (e.g., candidate) assisting UEs 100 may also announce it is available to act as assisting UE and its supported QoS using the authorized application ID in ProSe discovery (e.g., according to the steps 402-T1-1 and/or 402-T1-2 of the method 400), and the target UE 200 may prioritize such assisting UEs 100 supporting its required QoS.

FIG. 11 schematically illustrates a signaling diagram (which may imply a flowchart) of the main option 1, i.e. a method of indicating QoS requirement of SL positioning and/or SL ranging and/or the steps referred to by “-R1” and “-T1”.
Step 1 (e.g., step 502-T1-1 or 402-T1-1 or 602-R1): The UE 100 or 200 includes capability of its supported QoS for ranging and/or SL positioning and UE Policy Container in the Registration Request message (UE Policy Provisioning Request to request 5G ProSe policies) to the AMF.
Step 2 (e.g., as part of the step 602-T1): The AMF 300-1 sends Namf_Communication_N1MessageNotify request to the PCF 300-2 including the UE Policy Container received from UE 100 or 200.
Step 3 (e.g., step 502-R1 or 402-R1 or 602-T1): The PCF 300-2 receives UE Policy Container which indicates UE Policy Provisioning Request to request 5G ProSe policies. If the 5G ProSe policies are authorized based on AMF input, the PCF performs the UE Policy delivery procedure. The PCF-provided provision policy (e.g., parameters) include multiple authorized application IDs to differentiate ranging and/or SL positioning methods with different ranging and/or SL positioning QoS requirement, and optional ranging and/or SL positioning parameters for each authorized application ID.
Step 4 (e.g., step 502-T1-2 or 402-T1-2): In one case, the target UE 200 indicates ranging and/or SL positioning QoS requirement by the corresponding authorized application ID from Step 3, and one or more nearby UEs 100 (as candidate assisting UEs) monitor or check whether it (the UE 100) is authorized for the application ID to act as assisting UE 100 for the target UE 200. In another case, the one or more assisting UEs 100 announce their availability to act as assisting UE 100 and its respectively supported QoS using the authorized application ID in ProSe discovery, and the target UE 200 may select (e.g., prioritize) such assisting UEs 100 supporting its required QoS.

Main option 2 may comprise at least one of the following features or steps, optionally in combination with steps referred to by “-T2” and “-R2”.

The target UE 200 discovers one or more potential (i.e., candidate) assisting UEs 100 by legacy ProSe Discovery procedures without indicating QoS requirement for ranging/SL positioning.

Then, the target UE 100 sends QoS requirements for ranging and/or SL positioning to the discovered one or more UEs via PC5 signaling (e.g., according to the step 402-T2) comprising at least one of the following signaling alternatives
1) PC5-S signaling,
2) PC5-RRC signaling,
3) MAC CE based signaling,
4) L1 signaling (e.g., signaling carried on L1 physical channels including PSCCH, PSSCH, PSFCH etc.).

In one embodiment, the target UE 200 may indicate its reserved resource for ranging and/or SL positioning, and send a SL positioning reference signal (SL-PRS) at the next reserved resource for the potential assisting UEs 100 to measure and optionally request to send measurement reports.

Each discovered UE 100 assesses (e.g., checks) the received the QoS requirements from the target UE 200, and based on its capability (e.g., supported ranging and/or SL positioning QoS or methods, maximum bandwidth for transmission and receiving) and optional measurements of PC5 message and/or SL-PRS from target UE, the discovered UE 100 replies to the target UE 200 whether it is capable to act as assisting UE for the ranging and/or SL positioning with QoS requirement (e.g., according to the step 402-T2).
In one embodiment, discovered UE determines whether it can support the QoS requirements according to specified RAN4 performance requirement, e.g., its supported transmission bandwidth, the Eb/N0 and optional LoS/NLoS derived from the received message PC5 message and/or SL-PRS from target UE.
In one embodiment, discovered UE may send ACK/NACK bit as reply to indicate whether it is capable as assisting UE to support QoS requirement for ranging/SL positioning. In another embodiment, the discovered UE may send its measurement report to the target UE, and the target UE decide whether to keep the UE as assisting UE or not.
In one embodiment, if target UE send SL-PRS, the discovered UE may also send whether the reserved resource by target UE is preferred or not.

Main option 3 may comprise at least one of the following features or steps, optionally in combination with steps referred to by “-T3” and “-R3”.

The target UE 200 includes the QoS requirement in the ProSe Discovery message (e.g., according to the step 502-T3).

The UE (e.g., a target UE) would advertise its requirement in the discovery message (e.g., discovery solicitation). The receiver UE (e.g., a reference/assisting UE) will verify if it has the capability to fulfil such requirements; only then the receiver UE would send a response (e.g., discovery response) to participate in the ranging/SL positioning.

In another example, a reference/assisting UE may broadcast a discovery message (e.g., discovery announcement) in the proximity comprising the levels of QoS requirements for one or multiple positioning services/traffic types/sessions which can be met by this reference UE. Upon reception of the discovery message, a target UE may determine if itself can be served by this reference UE for the indicated positioning service in the discovery message.

The main option 3 may be implemented by modifying a PC5_DISCOVERY message, e.g. in the 3GPP document TS 24.334. A number of bits (e.g., 16) may be taken to indicate QoS requirement to request by target UE or the QoS requirement supported by the assisting/reference UE, and as a result the Spare IE size will increase by the bits size occupied by positioning QoS IE. In Prose Discovery Mode B, whether the UE is a target UE or an assisting/reference UE can be determined by the Target User Info in PC5_DISCOVERY message for Group Member Discovery Solicitation. In Prose Discovery Mode A, in most cases is considered sent by assisting U s (i.e. reference UEs) to broadcast its supported QoS in PC5_DISCOVERY message for Group Member Discovery Announcement.

For example, a table in the 3GPP document TS 24.334 may be modified as indicated below at the positions in italic type.

TABLE 11.2.5.1.7
PC5_DISCOVERY message for Group
Member Discovery Announcement

| | | | Length |
|---|---|---|---|
| Information Element | Type/Reference | Presence | (bits) |
| Message Type (NOTE) | Message Type | M | 8 |
| | 12.2.2.10 | | |
| Discovery Group ID | Binary | M | 24 |
| | 12.2.2.54 | | |
| Announcer Info | Binary | M | 48 |
| | 12.2.2.50 | | |
| ProSe UE ID | Binary | M | 24 |
| | 12.2.2.48 | | |
| Positioning QoS Info | Binary | C (NOTE2) | 16 |
| Spare | Binary | M | 88 (NOTE3) |
| | 12.2.2.56 | | |
| MIC | Binary | M | 32 |
| | 12.2.2.11 | | |
| UTC-based Counter LSB | Binary | M | 8 |
| | 12.2.2.22 | | |

(NOTE):
The Discovery Type is set to “Restricted discovery”, the Content Type is set to “Group Member Discovery Announcement or Group Member Discovery Response” and the Discovery Model is set to “Model A”.
(NOTE2):
If the Target User Info indicates it's for SL positioning and/or SL ranging, then Positioning QoS Info is present.
(NOTE3):
If Positioning QoS Info is present, the size decreases by the size of Positioning QoS Info.

TABLE 11.2.5.1.8
PC5_DISCOVERY message for Group
Member Discovery Solicitation

| | | | Length |
|---|---|---|---|
| Information Element | Type/Reference | Presence | (bits) |
| Message Type (NOTE 1) | Message Type | M | 8 |
| | 12.2.2.10 | | |
| Discovery Group ID | Binary | M | 24 |
| | 12.2.2.54 | | |
| Discoverer Info | Binary | M | 48 |
| | 12.2.2.50 | | |
| GMDS Composition | Binary | M | 8 |
| | 12.2.2.55 | | |
| Target User Info | Binary | C | 48 |
| | 12.2.2.52 | (NOTE 2) | |
| Target Group Info | Binary | C | 24 |
| | 12.2.2.53 | (NOTE 2) | |
| Positioning QoS Info | Binary | C | 16 |
| | | (NOTE4) | |
| Spare | Binary | M | 56 or 80 |
| | 12.2.2.56 | | (NOTE 3) |
| MIC | Binary | M | 32 |
| | 12.2.2.11 | | |
| UTC-based Counter LSB | Binary | M | 8 |
| | 12.2.2.22 | | |

(NOTE 1):
The Discovery Type is set to “Restricted discovery”, the Content Type is set to “Group Member Discovery Solicitation” and the Discovery Model is set to “Model B”.
(NOTE 2):
Presence of the Target User Info and of Target Group Info is indicated by the GMDS Composition.
(NOTE 3):
If the Target User Info is present, then the length of the Spare is 56 bits. If the Target Group Info is present, then the length of the Spare is 80 bits. If Positioning QoS Info is present, the size decreases by the size of Positioning QoS Info.
(NOTE4): If the Target User Info indicates it's for SL positioning and/or SL ranging, then Positioning QoS Info is present.

Alternatively or in addition, the following section may be included in the 3GPP document TS 24.334,

### ******Begin of Section******

### 12.2.2.YX Positioning QoS Info

This parameter is used to indicate, the QoS requirement for sidelink (SQ positioning and/or SL ranging in PC5_DISCOVERY message for Group Member Discovery Solicitation and Group Member Discovery Announcement.

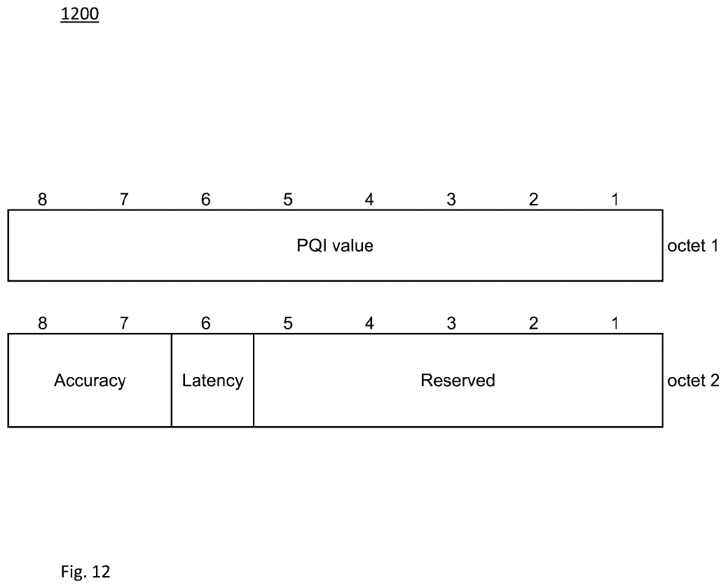

This parameter is coded as shown in FIG. 12.2.2.XX.1 and table 12.2.2.XX.1.

### ******End of Section******

FIG. 12 (e.g., FIG. 12.2.2.XX.1 of a correspondingly amended 3GPP document) indicates an embodiment of GMDS Composition parameter.

FIG. 12 schematically illustrates a data structure 1200 for implementing a control message exchanged between the at least one candidate assisting radio device 100 and the target radio device 200.

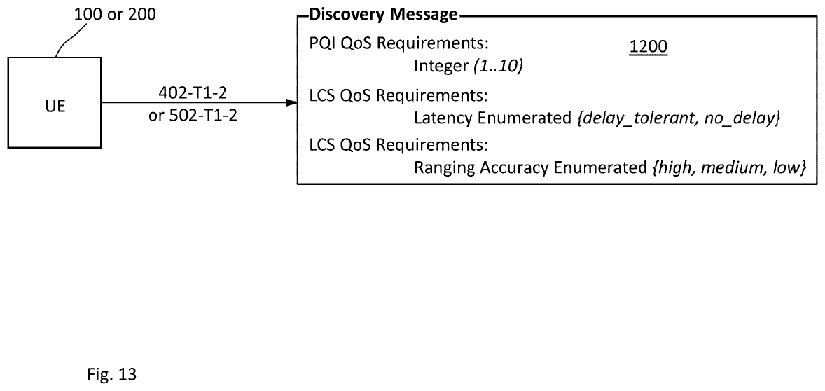

FIG. 13 schematically illustrates a data structure for a discovery message, which can be used in an embodiment of any one of the methods 400 and 500, e.g. including the data structure 1200.

Alternatively or in addition, below Table (e.g., Table 12.2.2.XX.1 of a correspondingly amended 3GPP document) may indicate examples of GMDS Composition parameter.

PQI value (octet 1)
LCS requirement Accuracy (octet 2)

| Bit | | |
|---|---|---|
| 8 | 7 | |
| 0 | 0 | Sidelink positioning/ranging accuracy requirement is low |
| 0 | 1 | Sidelink positioning/ranging accuracy requirement is |
| | | medium |
| 1 | 0 | Sidelink positioning/ranging accuracy requirement is high |
| 1 | 1 | Reserved for future |

LCS requirement Latency (octet 2)

| Bit | |
|---|---|
| 6 | |
| 0 | Sidelink positioning/ranging latency requirement is tolerant |
| 1 | Sidelink positioning/ranging latency requirement is no delay |

Bits 1-5 are reserved for future use.

In any aspect and embodiment, at least one of the following features may be included.

For any one of the above options or embodiments, if a neighbor UE 100 and/or discovered UE 100 replies to the target UE 200 indicating that it is not capable to act as an assisting UE for the target UE for the ranging and/or SL positioning with QoS requirements, the target UE 200 continues to select or reselects another neighbor UE to be as an assisting UE.

For any one of the above options or embodiments, the target UE 200 indicates the QoS requirements for a SL ranging/positioning session service via one of the below options.

Option 1: The QoS requirements are expressed via a service and/or traffic type priority indicator (e.g., PQI or a 5QI)

In this option, the PQI or the 5QI represents the QoS requirements for the ranging/positioning session service. The target IE may no need to include detailed QoS parameters/requirements in the signaling.
Option 2: Detailed QoS requirements (e.g. QoS parameters) may be included in the signaling.

The signaling may comprise detailed QoS requirements (e.g. parameters) comprising one or multiple of the below elements, for example:
Session level bit rate
Bit rate on the concerned PC5 link
Aggregated bit rate on the PC5 interface (may comprise one or multiple PC5 links)
Bit rate of flows
Bit rate of radio bearers
Averaged or maximum packet delay of flows or radio bearers
Averaged or maximum packet error rate of flows or radio bearers
Total delivered data volume of concerned flows or radio bearers
Number of hops that one or multiple packets of a flow or service have traversed
Packet error rate of flows or radio bearers
Number of lost packets of flows or radio bearers
Ratio of packet loss of flows or radio bearers
Positioning accuracy requirement
Bandwidth for transmitting and receiving sidelink reference signal for ranging/SL positioning
RSRP

In case option 1 is chosen, if the target UE 200 has selected a non-standardized PQI (PC5 QoS indicator) or 5QI (5G QoS indicator) for the session or service, the target UE 200 may not include this non-standardized PQI or 5QI in the signaling since the neighbor UE 100 may not be able to interpret this non-standardized PQI or 5QI correctly, instead the target UE can include another standardized PQI or 5QI value in the signaling which can best match the QoS characteristics of the SL ranging/positioning session/service.

In one option, the target UE may include both a PQI or 5QI value and one or multiple additional QoS requirements/parameters in the signaling to together indicate the QoS requirements for the SL ranging/positioning session/service. This is useful especially when these additional QoS requirements/parameters are not covered in the PQI/5QI QoS table. It may also happen that the additional QoS requirements/parameters give finer values/ranges than the ones in the PQI/5QI QoS table.
Option 3: The level of QoS requirements of the positioning service/traffic type/session which needs to/can be met is included in the signaling.

Different from Option 1 and Option 2, instead of including detailed QoS requirements/parameters in the signaling, the level of QoS requirements of the service/traffic type/session which needs to be met is included in the signaling. All UEs in the proximity should have a common understanding to levels of QoS requirements of different services/traffic types/sessions.

The PQI QoS parameters are categorized with an index. Similarly, the location services quality of service (LCS QoS) is also categorized with index or ranging quality (granularity) requirements such as low, medium, high.

As an example, the UE (e.g., a target UE) as may advertise its requirement in the discovery message (e.g., discovery solicitation). FIG. 13 schematically illustrates an example of the discovery message, which may be implemented using at least one of the indicated features in the discovery message.

The receiver UE (e.g., a reference/assist ULE) will verify if it has the capability to fulfil such requirements; only then the receiver UE would send a response (e.g., discovery response) to participate in the ranging.

In another example, a reference/assist UE 100 may broadcast a discovery message (e.g., discovery announcement) in the proximity comprising the levels of QoS requirements for one or multiple positioning services/traffic types/sessions which can be met by this reference UE. Upon reception of the discovery message, a target UE may determine if itself can be served by this reference UE for the indicated positioning service in the discovery message.

In another example, the option 3 may be applicable to other signaling alternatives including at least one of the following signals.
1) PC5-S signaling
2) PC5-RRC signaling
3) MAC CE based signaling
4) L1 signaling (e.g., signaling carried on L1 physical channels including PSCCH, PSSCH, PSFCH etc.).

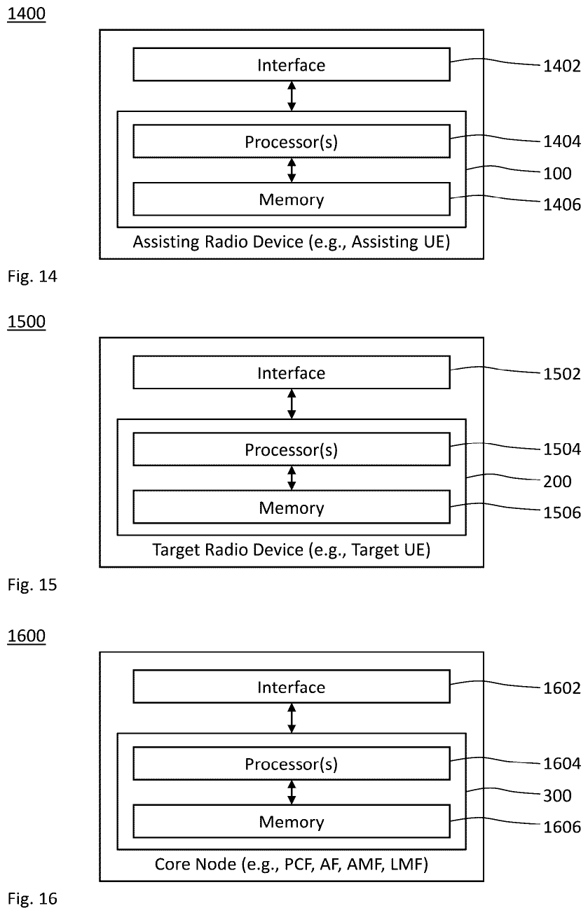

FIG. 14 shows a schematic block diagram for an embodiment of the device 100. The device 100 comprises processing circuitry, e.g., one or more processors 1404 for performing the method 400 and memory 1406 coupled to the processors 1404. For example, the memory 1406 may be encoded with instructions that implement at least one of the modules 102-R, 102-T and 104.

The one or more processors 1404 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 100, such as the memory 1406, SL positioning assistance functionality. For example, the one or more processors 1404 may execute instructions stored in the memory 1406. Such functionality may include providing various features and steps discussed herein, including any of the benefits disclosed herein. The expression “the device being operative to perform an action” may denote the device 100 being configured to perform the action.

As schematically illustrated in FIG. 14, the device 100 may be embodied by an assisting radio device 1400, e.g., functioning as a UE. The assisting radio device 1400 comprises a radio interface 1402 coupled to the device 100 for radio communication with one or more target radio devices, e.g., functioning as a target UE.

FIG. 15 shows a schematic block diagram for an embodiment of the device 200. The device 200 comprises processing circuitry, e.g., one or more processors 1504 for performing the method 400 and memory 1506 coupled to the processors 1504. For example, the memory 1506 may be encoded with instructions that implement at least one of the modules 202-T, 202-R and 204.

The one or more processors 1504 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 200, such as the memory 1506, SL positioning target functionality. For example, the one or more processors 1504 may execute instructions stored in the memory 1506. Such functionality may include providing various features and steps discussed herein, including any of the benefits disclosed herein. The expression “the device being operative to perform an action” may denote the device 200 being configured to perform the action.

As schematically illustrated in FIG. 15, the device 200 may be embodied by a target radio device 1500, e.g., functioning as a UE. The target radio device 1500 comprises a radio interface 1502 coupled to the device 200 for radio communication with one or more transmitting stations, e.g., functioning as a transmitting base station or a transmitting UE.

FIG. 16 shows a schematic block diagram for an embodiment of the device 300. The device 300 comprises processing circuitry, e.g., one or more processors 1604 for performing the method 600 and memory 1606 coupled to the processors 1604. For example, the memory 1606 may be encoded with instructions that implement at least one of the modules 302-T, 302-R and 304.

The one or more processors 1604 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 300 or 1600, such as the memory 1606, receiver functionality. For example, the one or more processors 1604 may execute instructions stored in the memory 1606. Such functionality may include providing various features and steps discussed herein, including any of the benefits disclosed herein. The expression “the device being operative to perform an action” may denote the device 300 or 1600 being configured to perform the action.

As schematically illustrated in FIG. 16, the device 300 may be embodied by a network node 1600, e.g., functioning as a radio access network node or a core network node. The network node 1600 comprises a (e.g., radio) interface 1602 coupled to the device 300 for (e.g., radio) communication with one or more radio devices (e.g., through a radio access network).

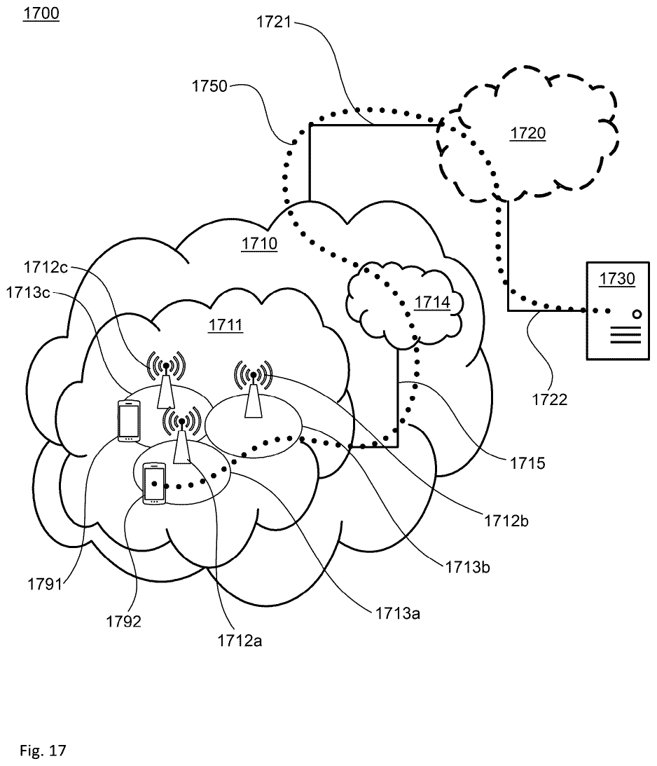

With reference to FIG. 17, in accordance with an embodiment, a communication system 1700 includes a telecommunication network 1710, such as a 3GPP-type cellular network, which comprises an access network 1711, such as a radio access network, and a core network 1714. The access network 1711 comprises a plurality of base stations 1712a, 1712b, 1712c, such as NBs, eNBs, gNBs or other types of wireless access points, each defining a corresponding coverage area 1713a, 1713b, 1713c. Each base station 1712a, 1712b, 1712c is connectable to the core network 1714 over a wired or wireless connection 1715. A first user equipment (UE) 1791 located in coverage area 1713c is configured to wirelessly connect to, or be paged by, the corresponding base station 1712c. A second UE 1792 in coverage area 1713a is wirelessly connectable to the corresponding base station 1712a. While a plurality of UEs 1791, 1792 are illustrated in this example, the disclosed embodiments are equally applicable to a situation where a sole UE is in the coverage area or where a sole UE is connecting to the corresponding base station 1712.

Any of the base stations 1712 may embody the device 300. Any of the UEs 1791, 1792 may embody the device 100 and/or 200.

The telecommunication network 1710 is itself connected to a host computer 1730, which may be embodied in the hardware and/or software of a standalone server, a cloud-implemented server, a distributed server or as processing resources in a server farm. The host computer 1730 may be under the ownership or control of a service provider, or may be operated by the service provider or on behalf of the service provider. The connections 1721, 1722 between the telecommunication network 1710 and the host computer 1730 may extend directly from the core network 1714 to the host computer 1730 or may go via an optional intermediate network 1720. The intermediate network 1720 may be one of, or a combination of more than one of, a public, private or hosted network; the intermediate network 1720, if any, may be a backbone network or the Internet; in particular, the intermediate network 1720 may comprise two or more sub-networks (not shown).

The communication system 1700 of FIG. 17 as a whole enables connectivity between one of the connected UEs 1791, 1792 and the host computer 1730. The connectivity may be described as an over-the-top (OTT) connection 1750. The host computer 1730 and the connected UEs 1791, 1792 are configured to communicate data and/or signaling via the OTT connection 1750, using the access network 1711, the core network 1714, any intermediate network 1720 and possible further infrastructure (not shown) as intermediaries. The OTT connection 1750 may be transparent in the sense that the participating communication devices through which the OTT connection 1750 passes are unaware of routing of uplink and downlink communications. For example, a base station 1712 need not be informed about the past routing of an incoming downlink communication with data originating from a host computer 1730 to be forwarded (e.g., handed over) to a connected UE 1791. Similarly, the base station 1712 need not be aware of the future routing of an outgoing uplink communication originating from the UE 1791 towards the host computer 1730.

By virtue of the method 400 or 500 being performed by any one of the UEs 1791 or 1792 and/or the method 600 by any one of the base stations 1712, the positing feature or performance or range or latency of the OTT connection 1750 can be improved, e.g., in terms of increased throughput and/or reduced latency and/or more accurate positing. More specifically, the host computer 1730 may indicate to the RAN 710 or the radio device 100 or 200 (e.g., on an application layer) the QoS of the positioning. Alternatively or in addition, the host computer 1730 may embody the device 300.

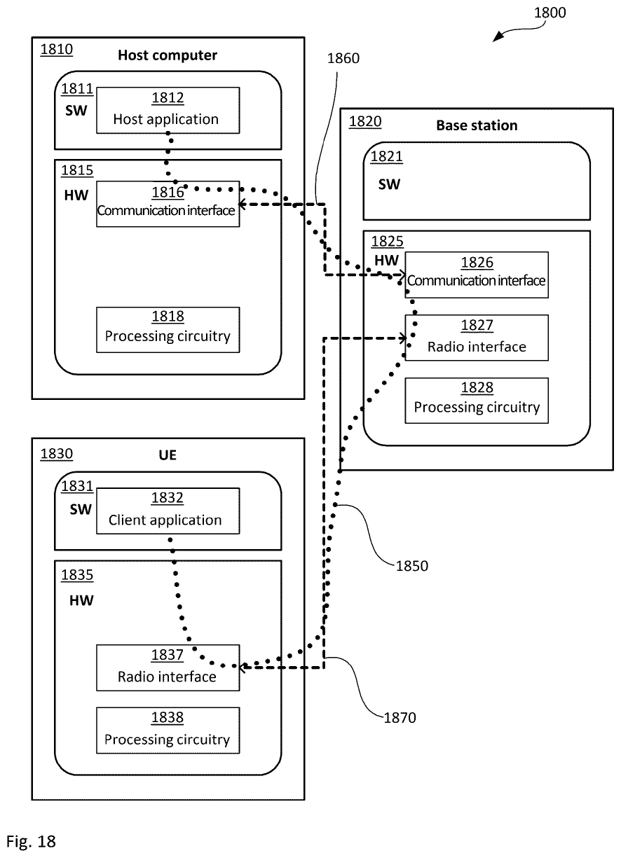

Example implementations, in accordance with an embodiment of the UE, base station and host computer discussed in the preceding paragraphs, will now be described with reference to FIG. 18. In a communication system 1800, a host computer 1810 comprises hardware 1815 including a communication interface 1816 configured to set up and maintain a wired or wireless connection with an interface of a different communication device of the communication system 1800. The host computer 1810 further comprises processing circuitry 1818, which may have storage and/or processing capabilities. In particular, the processing circuitry 1818 may comprise one or more programmable processors, application-specific integrated circuits, field programmable gate arrays or combinations of these (not shown) adapted to execute instructions. The host computer 1810 further comprises software 1811, which is stored in or accessible by the host computer 1810 and executable by the processing circuitry 1818. The software 1811 includes a host application 1812. The host application 1812 may be operable to provide a service to a remote user, such as a UE 1830 connecting via an OTT connection 1850 terminating at the UE 1830 and the host computer 1810. In providing the service to the remote user, the host application 1812 may provide user data, which is transmitted using the OTT connection 1850. The user data may depend on the location of the UE 1830. The user data may comprise auxiliary information or precision advertisements (also: ads) delivered to the UE 1830. The location may be reported by the UE 1830 to the host computer, e.g., using the OTT connection 1850, and/or by the base station 1820, e.g., using a connection 1860.

The communication system 1800 further includes a base station 1820 provided in a telecommunication system and comprising hardware 1825 enabling it to communicate with the host computer 1810 and with the UE 1830. The hardware 1825 may include a communication interface 1826 for setting up and maintaining a wired or wireless connection with an interface of a different communication device of the communication system 1800, as well as a radio interface 1827 for setting up and maintaining at least a wireless connection 1870 with a UE 1830 located in a coverage area (not shown in FIG. 18) served by the base station 1820. The communication interface 1826 may be configured to facilitate a connection 1860 to the host computer 1810. The connection 1860 may be direct, or it may pass through a core network (not shown in FIG. 18) of the telecommunication system and/or through one or more intermediate networks outside the telecommunication system. In the embodiment shown, the hardware 1825 of the base station 1820 further includes processing circuitry 1828, which may comprise one or more programmable processors, application-specific integrated circuits, field programmable gate arrays or combinations of these (not shown) adapted to execute instructions. The base station 1820 further has software 1821 stored internally or accessible via an external connection.

The communication system 1800 further includes the UE 1830 already referred to. Its hardware 1835 may include a radio interface 1837 configured to set up and maintain a wireless connection 1870 with a base station serving a coverage area in which the UE 1830 is currently located. The hardware 1835 of the UE 1830 further includes processing circuitry 1838, which may comprise one or more programmable processors, application-specific integrated circuits, field programmable gate arrays or combinations of these (not shown) adapted to execute instructions. The UE 1830 further comprises software 1831, which is stored in or accessible by the UE 1830 and executable by the processing circuitry 1838. The software 1831 includes a client application 1832. The client application 1832 may be operable to provide a service to a human or non-human user via the UE 1830, with the support of the host computer 1810. In the host computer 1810, an executing host application 1812 may communicate with the executing client application 1832 via the OTT connection 1850 terminating at the UE 1830 and the host computer 1810. In providing the service to the user, the client application 1832 may receive request data from the host application 1812 and provide user data in response to the request data. The OTT connection 1850 may transfer both the request data and the user data. The client application 1832 may interact with the user to generate the user data that it provides.

It is noted that the host computer 1810, base station 1820 and UE 1830 illustrated in FIG. 18 may be identical to the host computer 1730, one of the base stations 1712a, 1712b, 1712c and one of the UEs 1791, 1792 of FIG. 17, respectively. This is to say, the inner workings of these entities may be as shown in FIG. 18, and, independently, the surrounding network topology may be that of FIG. 17.

In FIG. 18, the OTT connection 1850 has been drawn abstractly to illustrate the communication between the host computer 1810 and the UE 1830 via the base station 1820, without explicit reference to any intermediary devices and the precise routing of messages via these devices. Network infrastructure may determine the routing, which it may be configured to hide from the UE 1830 or from the service provider operating the host computer 1810, or both. While the OTT connection 1850 is active, the network infrastructure may further take decisions by which it dynamically changes the routing (e.g., on the basis of load balancing consideration or reconfiguration of the network).

The wireless connection 1870 between the UE 1830 and the base station 1820 is in accordance with the teachings of the embodiments described throughout this disclosure. One or more of the various embodiments improve the performance of OTT services provided to the UE 1830 using the OTT connection 1850, in which the wireless connection 1870 forms the last segment. More precisely, the teachings of these embodiments may reduce the latency and improve the data rate and thereby provide benefits such as better responsiveness and improved QoS.

A measurement procedure may be provided for the purpose of monitoring data rate, latency, QoS and other factors on which the one or more embodiments improve. There may further be an optional network functionality for reconfiguring the OTT connection 1850 between the host computer 1810 and UE 1830, in response to variations in the measurement results. The measurement procedure and/or the network functionality for reconfiguring the OTT connection 1850 may be implemented in the software 1811 of the host computer 1810 or in the software 1831 of the UE 1830, or both. In embodiments, sensors (not shown) may be deployed in or in association with communication devices through which the OTT connection 1850 passes; the sensors may participate in the measurement procedure by supplying values of the monitored quantities exemplified above, or supplying values of other physical quantities from which software 1811, 1831 may compute or estimate the monitored quantities. The reconfiguring of the OTT connection 1850 may include message format, retransmission settings, preferred routing etc.; the reconfiguring need not affect the base station 1820, and it may be unknown or imperceptible to the base station 1820. Such procedures and functionalities may be known and practiced in the art. In certain embodiments, measurements may involve proprietary UE signaling facilitating the host computer's 1810 measurements of throughput, propagation times, latency and the like. The measurements may be implemented in that the software 1811, 1831 causes messages to be transmitted, in particular empty or “dummy” messages, using the OTT connection 1850 while it monitors propagation times, errors etc.

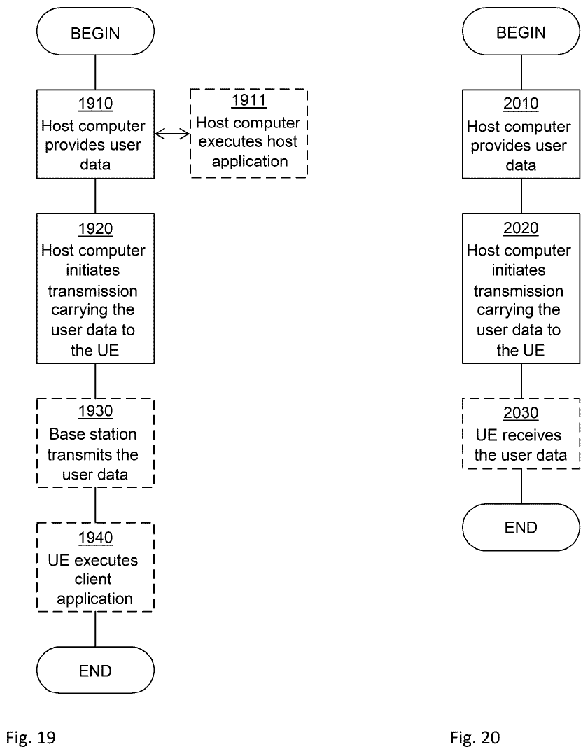

FIG. 19 is a flowchart illustrating a method implemented in a communication system, in accordance with one embodiment. The communication system includes a host computer, a base station and a UE which may be those described with reference to FIGS. 17 and 18. For simplicity of the present disclosure, only drawing references to FIG. 19 will be included in this paragraph. In a first step 1910 of the method, the host computer provides user data. In an optional substep 1911 of the first step 1910, the host computer provides the user data by executing a host application. In a second step 1920, the host computer initiates a transmission carrying the user data to the UE. In an optional third step 1930, the base station transmits to the UE the user data which was carried in the transmission that the host computer initiated, in accordance with the teachings of the embodiments described throughout this disclosure. In an optional fourth step 1940, the UE executes a client application associated with the host application executed by the host computer.

FIG. 20 is a flowchart illustrating a method implemented in a communication system, in accordance with one embodiment. The communication system includes a host computer, a base station and a UE which may be those described with reference to FIGS. 17 and 18. For simplicity of the present disclosure, only drawing references to FIG. 20 will be included in this paragraph. In a first step 2010 of the method, the host computer provides user data. In an optional substep (not shown) the host computer provides the user data by executing a host application. In a second step 2020, the host computer initiates a transmission carrying the user data to the UE. The transmission may pass via the base station, in accordance with the teachings of the embodiments described throughout this disclosure. In an optional third step 2030, the UE receives the user data carried in the transmission.

As has become apparent from above description, at least some embodiments of the technique enable to choose (i.e., select or determine) one or more suitable assistance (i.e., assisting) UEs for SL positioning (e.g., SL ranging), which guarantees positioning QoS. Moreover, same or further embodiments are also beneficial to save latency and resources as it avoids performing SL positioning (e.g., SL ranging) with unsuitable assistance UEs and redo the process again.

Many advantages of the present invention will be fully understood from the foregoing description, and it will be apparent that various changes may be made in the form, construction and arrangement of the units and devices without departing from the scope of the invention and/or without sacrificing all of its advantages. Since the invention can be varied in many ways, it will be recognized that the invention should be limited only by the scope of the following claims.

1. A method performed by a candidate assisting radio device or assisting radio device for sidelink positioning, SL positioning, of a target radio device using a SL between the target radio device and the assisting radio device, the method comprising:
receiving a control message indicative of a QoS required for the SL positioning, wherein the received control message is a discovery message or is received in a direct discovery for the SL;
performing a SL discovery procedure with the target radio device; and
assisting the SL positioning as the assisting radio device if the candidate assisting radio device fulfills the required QoS.

2. The method of claim 1, wherein the control message is received from the target radio device; and/or
wherein the received control message is indicative of an application identifier, ID, wherein the application ID is indicative of or associated with the QoS required by the target radio device.

3. The method of claim 2,
wherein the received control message is indicative of a policy for the SL or an application identifier, ID, for the SL, wherein the application ID is indicative of or associated with the required QoS.

4. The method of claim 1, further comprising:
establishing a SL session with the target radio device,
wherein the SL positioning is selectively assisted by the candidate assisting radio device based on the received required QoS being fulfilled by a supported QoS.

5. The method of claim 1
wherein the receiving of the control message comprises receiving a discovery message for discovering the target radio device, wherein the discovery message is indicative of the QoS required for the SL positioning.

6. The method of claim 5, further comprising:
transmitting, responsive to the received discovery message, a reply message to the target radio device if or only if a supported QoS is fulfilling the required QoS for the SL positioning.

7. The method of claim 1, wherein assisting the SL positioning comprises at least one of receiving a reference signal in the SL from the target radio device to at the assisting radio device and transmitting a reference signal in the SL from the assisting radio device at the target radio device.

8. The method of claim 1, wherein the required QoS is indicative of at least one of an accuracy of the SL positioning, a latency, a packet delay budget, a packet error rate, and a packet loss rate.

9. The method of claim 1, wherein the required QoS or the supported QoS is expressed via a service or traffic type priority indicator, comprising a PC5 QoS indicator (PQI) or a 5G QoS indicator (5QI), or
wherein the required QoS or the supported QoS is indicative of at least one of: a session level bit rate of the SL, a bit rate on the SL, aggregated bit rate on a PC5 interface used by the SL, a bit rate of flows, a bit rate of radio bearers, an averaged or maximum packet delay of flows or radio bearers, an averaged or maximum packet error rate of flows or radio bearers, a total delivered data volume of concerned flows or radio bearers, a number of hops that one or multiple packets of a flow or service have traversed, a packet error rate of flows or radio bearers, a number of lost packets of flows or radio bearers, a ratio of packet loss of flows or radio bearers, a positioning accuracy requirement, a bandwidth for transmitting and receiving sidelink reference signal for the SL positioning, and a reference signal received power, RSRP.

10. (canceled)

11. A method performed by a target radio device for sidelink positioning, SL positioning, of the target radio device using a SL between the target radio device and at least one assisting radio device, the method comprising:
transmitting a control message indicative of a QoS required for the SL positioning, wherein the transmitted control message is a discovery message or is transmitted in a direct discovery for the SL;
performing a SL discovery procedure with at least one candidate assisting radio device; and
performing the SL positioning using the at least one assisting radio device that fulfills the required QoS.

12. The method of claim 11, wherein the control message is transmitted to the at least one candidate assisting radio device; or
wherein the transmitted control message is indicative of an application identifier, ID, wherein the application ID is indicative of or associated with the QoS required by the target radio device.

13. The method of claim 11, wherein the transmitting of a control message comprises transmitting a first control message, wherein the first control message is a registration request message or a message for service authorization or a policy request message, or wherein the first control message is transmitted to a policy control function, PCF, or an application function, AF, or an access and mobility management function, AMF, or wherein the first control message is indicative of a radio device capability of the target radio device or the QoS required for the SL positioning; or
wherein the transmitting of a control message further comprises transmitting a second control message to the at least one candidate assisting radio device, wherein the second control message is indicative of the application ID, wherein second control message is a discovery message or is transmitted in a direct discovery for the SL or in direct communications using the SL.

14. The method of claim 11, further comprising:
establishing a SL session with at least one candidate assisting radio device,
wherein the SL positioning is performed using the at least one assisting radio device selected out of the at least one candidate assisting radio device based on an acknowledgment received responsive to the transmitted control message indicative of the required QoS.

15. The method of claim 11, wherein the transmitting of the control message comprises transmitting a discovery message for discovering the at least one assisting radio device, wherein the discovery message is indicative of the QoS required for the SL positioning.

16. The method of claim 15, further comprising:
receiving, responsive to the transmitted discovery message, a reply message from the at least one assisting radio device, each of which is capable of fulfilling the QoS requirement for the SL positioning.

17. The method of claim 11, wherein performing the SL positioning comprises at least one of transmitting a reference signal in the SL from the target radio device to at least one assisting radio device and receiving a reference signal in the SL from the at least one assisting radio device at the target radio device.

18. The method of claim 11, wherein the QoS requirement is indicative of at least one of an accuracy of the SL positioning, a latency, a packet delay budget, a packet error rate, and a packet loss rate.

19. The method of claim 11, wherein the required QoS or the supported QoS is expressed via a service or traffic type priority indicator, comprising PQI or 5QI, or
wherein the required QoS or the supported QoS is indicative of at least one of: a session level bit rate of the SL, a bit rate on the SL, aggregated bit rate on a PC5 interface used by the SL, a bit rate of flows, a bit rate of radio bearers, an averaged or maximum packet delay of flows or radio bearers, an averaged or maximum packet error rate of flows or radio bearers, a total delivered data volume of concerned flows or radio bearers, a number of hops that one or multiple packets of a flow or service have traversed, a packet error rate of flows or radio bearers, a number of lost packets of flows or radio bearers, a ratio of packet loss of flows or radio bearers, a positioning accuracy requirement, a bandwidth for transmitting and receiving sidelink reference signal for the SL positioning, and a reference signal received power, RSRP.

20-25. (canceled)

26. A non-transitory computer-readable medium storing thereon program code portions that, when executed on one or more computing devices, cause the one or more computing devices to perform the method of claim 1.

27-28. (canceled)

29. A radio device configured to:
receive a control message indicative of a QoS required for the SL positioning, wherein the received control message is a discovery message or is received in a direct discovery for the SL;
perform a SL discovery procedure with the target radio device; and
assist the SL positioning as the assisting radio device if the radio device fulfills the required QoS.

30-43. (canceled)
